(19) United States
(12) Patent Application Publication
(10) Pub. No.: US 2018/0072083 A1
(43) Pub. Date: Mar. 15, 2018

(54) THERMOREVERSIBLE RECORDING MEDIUM, IMAGE PROCESSING DEVICE USING THE SAME, AND CONVEYOR LINE SYSTEM

(71) Applicants: Toshiaki ASAI, Shizuoka (JP); Tomomi ISHIMI, Shizuoka (JP); Shinya KAWAHARA, Shizuoka (JP); Katsuya OHI, Shizuoka (JP)

(72) Inventors: Toshiaki ASAI, Shizuoka (JP); Tomomi ISHIMI, Shizuoka (JP); Shinya KAWAHARA, Shizuoka (JP); Katsuya OHI, Shizuoka (JP)

(21) Appl. No.: 15/558,730

(22) PCT Filed: Mar. 15, 2016
(86) PCT No.: PCT/JP2016/001458

§ 371 Date: Sep. 15, 2017

(30) Foreign Application Priority Data
Mar. 20, 2015 (JP) 2015-057024

(51) Int. Cl. B41M 5/327; B41M 7/00; B41M 5/333

(52) U.S. Cl. CPC B41M 5/3275; B41J 2202/37; B41M 5/3335; B41M 7/0009

(57) ABSTRACT

A thermoreversible recording medium including a support, and a thermoreversible recording layer, which is disposed on the support, and contains a leuco dye, and a reversible color developer, wherein an average particle diameter of granules in the thermoreversible recording layer is 0.35 micrometers or smaller.

### TECHNICAL FIELD

The present disclosure relates to thermoreversible recording media, image processing devices using the same, and conveyor line systems.

### BACKGROUND ART

Recently, an image processing device using a thermoreversible recording medium has been integrated into a conveyor line system that needs to manage transporting containers, such as reusable cartons, in logistics.

The thermoreversible recording medium is used as a label of the transporting container. Since the thermoreversible recording medium can be rewritable in a noncontact manner by heating the thermoreversible recording medium by a laser light emitted from the image processing device, a process for bonding and peeling labels is not necessary. Hence, use of the thermoreversible recording medium as a label can realize an efficient operation of the conveyor line system.

For example, the thermoreversible recording medium includes a particulate leuco dye, and a particulate reversible color developer, and can achieve a colored state (visualized state) by heating these compounds to a coloring temperature range or high, at which the compounds are melted, followed by rapidly cooling to coagulate in a mixed state. The thermoreversible recording medium in the colored state can be turned back to an erased state (invisible state) by heating an erasing temperature range, which is a temperature range lower than the coloring temperature range, followed by cooling after retaining the predetermined period, because the leuco dye and the reversible color developer are each separated into particles having small particle diameters.

There is however a problem that coloring density of an image recorded for the first time on the thermoreversible recording medium after production thereof, and coloring density of an image recorded at the second and the subsequent times are different depending on the particle diameters of the leuco dye and the reversible color developer contained in the thermoreversible recording medium, when irradiation energy of laser light during image recording is made constant in a rewriting process where image recording and erasing are repeated. Moreover, this problem becomes significant in a high temperature environment.

Specifically, in the conveyor line system, the number of scratches or dents formed on the transporting container increases, as the number of repeating usage increases, and the transporting container eventually cannot be used. In this case, a new transporting container to which a new thermoreversible recording medium is bonded is used instead of the transporting container that cannot be used any longer. The new thermoreversible recording medium bonded to the new transporting container is in a state of being recorded for the first time after production thereof, and the thermoreversible recording medium bonded to the transporting container, which has been used so far, is in a state of being recorded at the second and subsequent times. Accordingly, there is a difference in coloring density between the thermoreversible recording medium recorded for the first time after production thereof, and the thermoreversible recording medium recorded at the second and the subsequent times.

If a difference is made in the coloring density, the coloring density of the image on the thermoreversible recording medium the thermoreversible recording medium to be recorded for the first time after production thereof does not reach the predetermined coloring density and the image cannot be read, for example, in the case where the image is read (e.g., scanned) by a reading device, and the reading image density is set to coloring density of an image recorded at the second and the subsequent times. In the case where the reading image density is set at coloring density of an image recorded on a thermoreversible recording medium in a state of being recorded for the first time after production thereof, the thermoreversible recording medium in the recorded state at the second and the subsequent times is turned into an overheated state to cause color loss, and thus the coloring density is reduced and the image may not be read. In the aforementioned cases, a reading error of an image to be read occurs in the recording device, and a conveyor line system is stopped. In order to recover (restart) the system, time is required, and a throughput is lowered.

Moreover, considered is a method for changing irradiation energy of laser light applied after the second time, depending on the number of the image rewriting process performed. It is however difficult to identify the number of the image rewriting process performed. Moreover, a processing time for changing the irradiation energy depending on the number of the image rewriting process performed is required, when a high image rewriting processability of the conveyor line system per day is demanded at the same time. Accordingly, it is difficult to adapt the aforementioned method.

Therefore, proposed is a thermoreversible recording medium, on which coloring density of an image recorded for the first time after production thereof, and coloring density of an image recorded second time or later are the same, as the average volume particle diameter of the leuco dye, and the reversible color developer is adjusted to 1 micrometer or smaller (see, for example, PTL 1).

### SUMMARY OF INVENTION

### Technical Problem

The present invention aims to provide a thermoreversible recording medium, which can record images with stable coloring density without changing irradiation energy of laser light, even when a rewriting process of an image is repeatedly performed from a state of being recorded for the first time after production thereof.

### Solution to Problem

As the means for solving the aforementioned problem, the thermoreversible recording medium of the present invention includes a support and a thermoreversible recording layer on the support, the thermoreversible recording layer containing a leuco dye and a reversible color developer. An average particle diameter of granules in the thermoreversible recording layer is 0.35 micrometers or smaller.

### Advantageous Effects of Invention

The present invention can provide a thermoreversible recording medium, which can record images with stable coloring density without changing irradiation energy of laser light, even when a rewriting process of an image is repeatedly performed from a state of being recorded for the first time after production thereof.

### BRIEF DESCRIPTION OF DRAWINGS

FIG. 1A is a graph depicting a relationship between coloring density of a conventional thermoreversible recording medium and the irradiation energy.

FIG. 1B is a graph depicting a relationship between coloring density of the thermoreversible recording medium of the present invention, and the irradiation energy.

FIG. 2A is one example of a photograph, in which a cross-section of the thermoreversible recording medium is observed under a transmission electron microscope.

FIG. 2B is a photograph for indicating major axis diameters and minor axis diameters of particle diameters in the photograph of FIG. 2A.

FIG. 3 is a schematic cross-sectional view illustrating one example of a layer structure of the thermoreversible recording medium of the present invention.

FIG. 4A is a graph depicting a coloring-erasing mechanism of the thermoreversible recording medium.

FIG. 4B is a schematic view for illustrating a mechanism of a change between coloring and erasing of the thermoreversible recording medium.

FIG. 5 is a schematic view illustrating one example of the image recording unit.

FIG. 6 is a schematic view illustrating one example of the image erasing unit.

FIG. 7 is a schematic view illustrating one example of the conveyor line system.

FIG. 8 is a graph depicting a relationship between irradiation energy of laser light, and coloring density in Example 1.

FIG. 9 is a graph depicting a relationship between irradiation energy of laser light, and coloring density in Example 2.

FIG. 10 is a graph depicting a relationship between irradiation energy of laser light, and coloring density in Example 3.

FIG. 11 is a graph depicting a relationship between irradiation energy of laser light, and coloring density in Comparative Example 1.

### DESCRIPTION OF EMBODIMENTS

(Thermoreversible Recording Medium)

The thermoreversible recording medium of the present invention includes a support, and a thermoreversible recording layer, which is disposed on the support, and contains a leuco dye, and a reversible color developer. The average particle diameter of granules in the thermoreversible recording layer is 0.35 micrometers or smaller. The thermoreversible recording medium may further contain other ingredients, if necessary.

A shape, structure, and size of the thermoreversible recording medium of the present invention are not particularly limited, and can be appropriately selected depending on the intended purpose.

The thermoreversible recording medium includes a support, and a thermoreversible recording layer, and may further include appropriately selected other layers, if necessary. Each of the aforementioned layers may have a single layer structure, or a multilayer structure.

<Thermoreversible Recording Layer>

The thermoreversible recording layer contains a leuco dye, and a reversible color developer, and may further contain other ingredients, if necessary.

In an erased state, the thermoreversible recording layer includes granules.

The granules are solids of the leuco dye, and a reversible dying agent, contained in the thermoreversible recording layer.

Since the average particle diameter of the granules in the thermoreversible recording layer of the thermoreversible recording medium of the present invention is 0.35 micrometers or smaller, image recording of stable coloring density can be realized with the predetermined irradiation energy of laser light, even when a rewriting process of an image is repeated by performed on the thermoreversible recording medium from a state of being recorded for the first time after production thereof.

The specific mechanism for that an image can be recorded with stable coloring density by controlling the average particle diameter of the granules in the thermoreversible recording layer has not been clarified, but it is assumed that the following phenomenon occurs in the image recording process.

In order to color the thermoreversible recording layer from a state of being recorded for the first time after production thereof, irradiation energy of laser light that generates an amount of heat melting the leuco dye and the reversible color developer needs to be applied to allow the leuco dye and the reversible color developer to react with each other. In this process, irradiation energy tends to be larger, as the average particle diameter of the granules in the thermoreversible recording layer is larger.

In the area where the thermoreversible recording layer is colored from a state of being recorded for the first time after production thereof, and is then erased, the colored state, where the leuco dye and the reversible color developer are mixed and solidified, is turned into the erased state, where the leuco dye and the reversible color developer are separated, and thus the granules in the thermoreversible recording layer become granules having the average particle diameter of the predetermined size, that gives a stable state in the thermoreversible recording layer. In order to color the thermoreversible recording layer from the aforementioned state, irradiation energy of laser light that generates an amount of heat melting the granules of the certain particle diameters is applied.

In the case where the average particle diameter of the granules in the thermoreversible recording layer in a state of being recorded for the first time after production thereof and that of the granules in the thermoreversible recording layer in a state of being at the second and subsequent times are the same, irradiation energy of laser light required for coloring the thermoreversible recording layer can be the same. In the case where the average particle diameter of the granules in the thermoreversible recording layer is different between the aforementioned states, however, irradiation energy of laser light required for color the thermoreversible recording layer is different.

It has been found in the present invention that irradiation energy of laser light required for coloring the thermoreversible recording layer can be bade same between the thermoreversible recording layer in a state of being recorded for the first time after production thereof and that in a state of being at the second and subsequent times, by adjusting the average particle diameter of the granules in the thermoreversible recording layer to 0.35 micrometers or smaller.

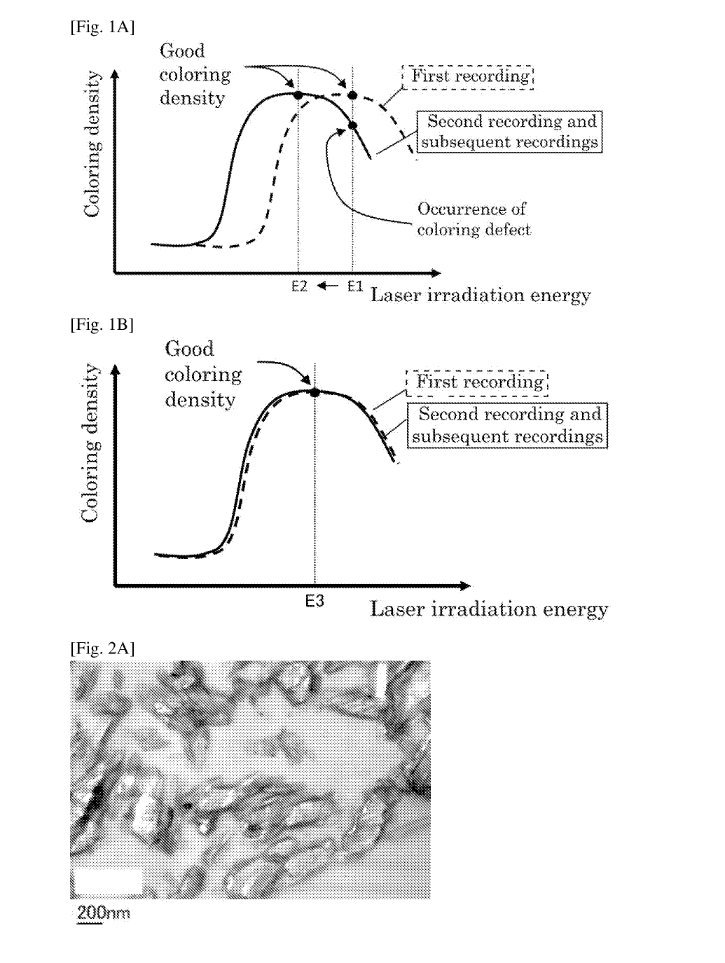

FIG. 1A is a graph depicting a relationship between coloring density of a conventional thermoreversible recording medium and irradiation energy, a vertical axis depicts coloring density, and a horizontal axis depicts irradiation energy of laser. The dashed line in FIG. 1A represents a relationship between coloring density of the thermoreversible recording medium R1 (first recording) in a state of being recorded for the first time after production thereof, to which an image is recorded for the first time after production thereof, and irradiation energy. The solid line in FIG. 1A represents a relationship between coloring density of the thermoreversible recording medium R2 (second recording or further recording) of the recorded state to which an image is recorded at the second and the subsequent times, and irradiation energy.

FIG. 1B is a graph depicting a relationship between coloring density of the thermoreversible recording medium of the present invention and irradiation energy, a vertical axis depicts coloring density, and a horizontal axis depicts irradiation energy of laser. Similarly to FIG. 1A, the dashed line in FIG. 1B represents a relationship between coloring density of the thermoreversible recording medium R1 (first recording) of an unrecorded state, to which an image is recorded for the first time after production thereof, and irradiation energy. The solid line in FIG. 1B represents a relationship between coloring density of the thermoreversible recording medium R2 (the second and subsequent recordings) of the recorded state to which an image is recorded for the second time or further recording, and irradiation energy.

It is confirmed in FIG. 1A from comparison between R1 and R2 in terms of the relationship between the coloring density and the irradiation energy that R1 has higher irradiation energy of laser to reach the region where the coloring density becomes high, than R2.

An image having high coloring density can be recorded by applying laser light having the irradiation energy E1 to the thermoreversible recording medium R1. If laser light having the irradiation energy is applied to the thermoreversible recording medium R2, however, the thermoreversible recording medium R2 may be overheated in the second image recording process to cause color loss, and coloring density may be reduced, as the granules in the thermoreversible recording layer of the thermoreversible recording medium R2 have the average particle diameter of the predetermined size that creates a stable state in the thermoreversible recording layer. In order to prevent color loss, therefore, irradiation energy of laser light applied to the thermoreversible recording medium of the recorded state (at the second and the subsequent times) needs to be changed from the irradiation energy E1 to the irradiation energy E2, with which coloring density of R2 becomes excellent.

When laser light of the irradiation energy E2 is applied to the thermoreversible recording medium R2, moreover, an image having high coloring density can be recorded. If laser light having the irradiation energy E2 is applied to the thermoreversible recording medium R1, however, irradiation energy is insufficient for an image recording process of a first time, and thus coloring density tends to be low, as the granules in the thermoreversible recording layer of R1 has the larger average particle diameter than that of the granules in the thermoreversible recording layer of R2. In order to prevent insufficient irradiation energy, therefore, irradiation energy of laser light applied for the first recording needs to be changed from the irradiation energy E2 to the irradiation energy E1, with which coloring density of R2 becomes excellent. If the irradiation energy applied is fixed to the irradiation energy E1, therefore, coloring density tends to be low on the thermoreversible recording medium in the recorded state at or after the second recording. If the irradiation energy applied is fixed to the irradiation energy E2, meanwhile, coloring density tends to be low on the thermoreversible recording medium recorded for the first time after production thereof.

Since the average particle diameter of granules in the thermoreversible recording layer of the thermoreversible recording medium of the present invention is 0.35 micrometers or smaller, in FIG. 1B, the relationship between the coloring density of the thermoreversible recording medium R1, to which an image is recorded for the first time after production thereof, and the irradiation energy, becomes closer to the relationship between the coloring density of the thermoreversible recording medium R2 and the irradiation energy. Accordingly, images having a stable coloring density can be recorded with laser light having the predetermined irradiation energy E3, even if the images are repeatedly rewritten from a state of being recorded for the first time after production thereof.

The average particle diameter of the granules is 0.35 micrometers or smaller, preferably 0.30 micrometers or smaller, and more preferably 0.28 micrometers or smaller. When the average particle diameter of the granules is 0.35 micrometers or smaller, images of stable density can be recorded even after repeatedly performing a rewriting process of an image, when the predetermined energy of laser light is applied.

Note that, the term “particle diameter” used in the present invention means a value that is square root of the product of a and b, where a is a major axis diameter of the granule in the thermoreversible recording layer and b is a minor axis diameter of the granule in the thermoreversible recording layer, when a cross-sectional surface of the thermoreversible recording medium, obtained by cutting the thermoreversible recording medium in the direction vertical to the thickness direction, is observed under a transmission electron microscope (device name: JEM-2100, manufactured by JEOL Ltd., magnification: from 3,000 times through 10,000 times).

The value that is square root of the product of a and b is a value corresponding to a diameter of circle, when the granule in the thermoreversible recording layer, which is an irregular shape, is regarded as a circle.

Moreover, the average particle diameter is the average value of particles diameters of 100 particles within 2 or 3 image photographs or image files as observed.

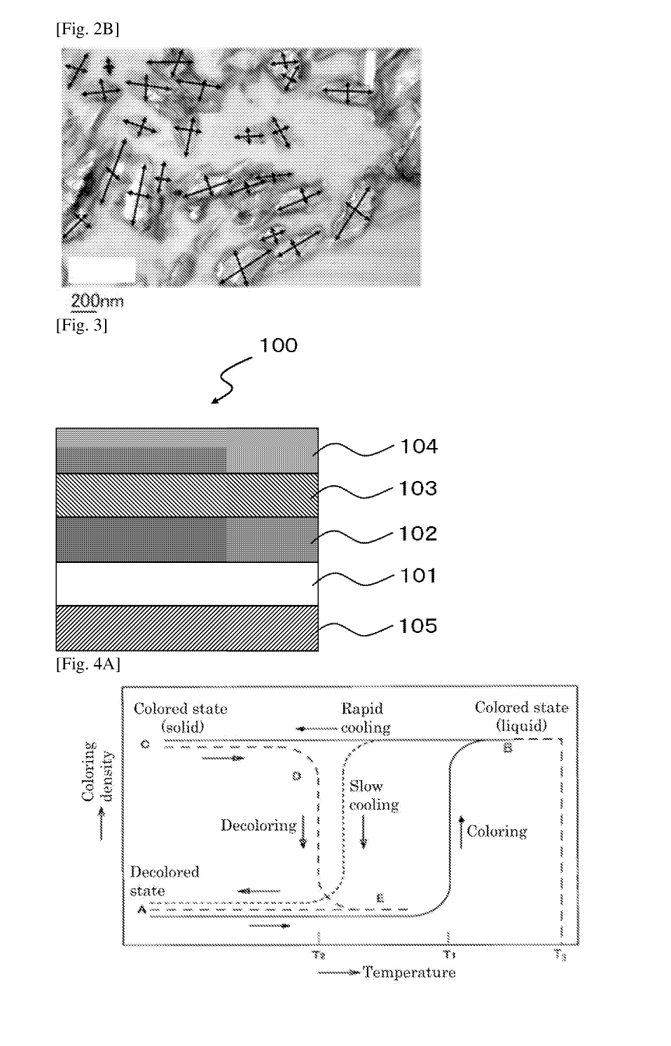

As an example for determining the average particle diameter, the method thereof is described with reference to FIGS. 2A and 2B. FIG. 2A is one example of a photograph in which a cross-section of the thermoreversible recording medium is observed under a transmission electron microscope. FIG. 2B is a photograph for indicating major axis diameters and minor axis diameters of particle diameters in the photograph of FIG. 2A. Note that, it is considered that the reversible color developer in the thermoreversible recording layer is mainly observed as particles in FIGS. 2A and 2B.

The particle diameters of the granules in the photograph of FIG. 2A are measured to determine major axis diameters a and minor axis diameters b as in FIG. 2B. The value of square root of the product of a and b is determined. The average particle diameter can be calculated from the average value of particle diameters of 100 granules.

—Measurement of Average Particle Diameter of Granules by Transmission Electron Microscope—

An example of measuring conditions of the average particle diameter of the granules by means of a transmission electron microscope is described below. However, the conditions and method for the measurement are not limited to the following conditions and method, and similar devices, conditions for a device for use, treating methods of the thermoreversible recording medium, and measuring methods of the thermoreversible recording medium are appropriately selected.

For example, the average particle diameter of the granules can be measured by a transmission electron microscope (device name: JEM-2100) manufactured by JEOL Ltd.

As for a measuring target, for example, the thermoreversible recording medium is embedded using a 30 min-curable epoxy resin, followed by trimming with a glass knife, and the resultant is cut into a cut piece by means of an ultramicrotome. The cut piece is then secured on a mesh, and is preferably subjected to steam dyeing using a RuO₄ aqueous solution.

The cutting conditions by the ultramicrotome are not particularly limited, and can be appropriately selected depending on the intended purpose. It is preferred that the thermoreversible recording medium be cut in the vertical direction relative to the thickness direction thereof by means of a diamond knife with the cut thickness of 80 nm, and the cutting speed of from 0.2 mm/sec through 0.6 mm/sec.

The observation conditions are not particularly limited, and can be appropriately selected depending on the intended purpose. It is preferred that the observation be performed by a bright-field method with the accelerating voltage of 200 kV, and as setting conditions, the spot size of 3, CL of 1, OL of 3, and Alpha of 3.

Examples of the method for controlling the average particle diameter of the granules in the thermoreversible recording layer include a method where pulverization dispersion conditions of ingredients using a ball mill, or stirring conditions are controlled when a thermoreversible recording layer coating solution for producing the thermoreversible recording layer is prepared.

—Leuco Dye—

The leuco dye is a colorless, or pale-color dye precursor. The leuco dye is not particularly limited, and can be appropriately selected depending on the intended purpose. Examples of the leuco dye include leuco compounds of dyes, such as a triphenylmethane-based compound, a fluoran-based compound, a phenothiazine-based compound, an auramine-based compound, a spiropyran-based compound, and an indolinophthalide-based compound. These compounds may be used alone or in combination.

Specific examples of the leuco dye include 2-anilino-3-methyl-6-dibutylaminofluoran, 2-anilino-3-methyl-6-diethylaminofluoran, 3,3-bis(p-dimethylaminophenyl)-phthalide, 3,3-bis(p-dimethylaminophenyl)-6-dimethylaminophthalide (which is also known as crystal violet lactone), 3,3-bis(p-dimethylaminophenyl)-6-diethylaminophthalide, 3,3-bis(p-dimethylaminophenyl)-6-chlorophthalide, 3,3-bis(p-dibutylaminophenyl)phthalide, 3-cyclohexylamino-6-chlorofluoran, 3-dimethylamino-5,7-dimethylfluoran, 3-diethylamino-7-chlorofluoran, 3-diethylamino-7-methylfluoran, 3-diethylamino-7,8-benzofluoran, 3-diethylamino-6-methyl-7-chlorofluoran, 3-(N-p-tolyl-N-ethylamino)-6-methyl-7-anilinofluoran, 2-{N-(3′-trifluoromethylphenyl)amino}-6-diethylaminofluoran, 2-{3,6-bis(diethylamino)-9-(o-chloroanilino)xanthylbenzoic acid lactam}, 3-diethylamino-6-methyl-7-(m-trichloromethylanilino)fluoran, 3-diethylamino-7-(o-chloroanilino)fluoran, 3-pyrrolidino-6-methyl-7-anilinofluoran, 3-di-n-butylamino-7-o-chloroanilino)fluoran, 3-N-methyl-N,n-amylamino-6-methyl-7-anilinofluoran, 3-N-methyl-N-cyclohexylamino-6-methyl-7-anilinofluoran, 3-diethylamino-6-methyl-7-anilinofluoran, 3-(N,N-diethylamino)-5-methyl-7-(N,N-dibenzylamino)fluoran, benzoyl leuco methylene blue, 6′-chloro-8′-methoxy-benzoindolino-spiropyran, 6′-bromo-3′-methoxy-benzoindolino-spiropyran, 3-(2′-hydroxy-4′-dimethylaminophenyl)-3-(2′-methoxy-5′-chlorophenyl)phthalide, 3-(2′-hydroxy-4′-dimethylaminophenyl)-3-(2′-methoxy-5′-nitrophenyl)phthalide, 3-(2′-hydroxy-4′-diethylaminophenyl)-3-(2′-methoxy-5′-methylphenyl)phthalide, 3-(2′-methoxy-4′-dimethylaminophenyl)-3-(2′-hydroxy-4′-chloro-5′-methylphenyl)phthalide, 3-(N-ethyl-N-tetrahydrofurfuryl)amino-6-methyl-7-anilinofluoran, 3-N-ethyl-N-(2-ethoxypropyl)amino-6-methyl-7-anilinofluoran, 3-N-methyl-N-isobutyl-6-methyl-7-anilinofluoran, 3-morpholino-7-(N-propyl-trifluoromethylanilino)fluoran, 3-pyrrolidino-7-trifluoromethylanilinofluoran, 3-diethylamino-5-chloro-7-(N-benzyl-trifluoromethylanilino)fluoran, 3-pyrrolidino-7-(di-p-chlorophenyl)methylaminofluoran, 3-diethylamino-5-chloro-7-(α-phenylethylamino)fluoran, 3-(N-ethyl-p-toluidino)-7-(α-phenylethylamino)fluoran, 3-diethylamino-7-(o-methoxycarbonylphenylamino)fluoran, 3-diethylamino-5-methyl-7-(α-phenylethylamino)fluoran, 3-diethylamino-7-piperidinofluoran, 2-chloro-3-(N-methyltoluidino)-7-(p-n-butylanilino)fluoran, 3-di-n-butylamino-6-methyl-7-anilinofluoran, 3,6-bis(dimethylamino)fluorenespiro(9,3′)-6′-dimethylaminophthalide, 3-(N-benzyl-N-cyclohexylamino)-5,6-benzo-7-α-naphthylamino-4′-bromofluoran, 3-diethylamino-6-chloro-7-anilinofluoran, 3-diethylamino-6-methyl-7-cimetidino-4′,5′-benzofluoran, 3-N-methyl-N-isopropyl-6-methyl-7-anilinofluoran, 3-N-ethyl-N-isoamyl-6-methyl-7-anilinofluoran, 3-diethylamino-6-methyl-7-(2′,4′-dimethylanilino)fluoran, 3-morpholino-7-(N-propyl-trifluoromethylanilino)fluoran, 3-pyrrolidino-7-trifluoromethylanilinofluoran, 3-diethylamino-5-chloro-7-(N-benzyl-trifluoromethylanilino)fluoran, 3-pyrrolidino-7-(di-p-chlorophenyl)methylaminofluoran, 3-diethylamino-5-chloro-(α-phenylethylamino)fluoran, 3-(N-ethyl-p-toluidino)-7-(α-phenylethylamino)fluoran, 3-diethylamino-7-(o-methoxycarbonylphenylamino)fluoran, 3-diethylamino-5-methyl-7-(α-phenylethylamino)fluoran, 3-diethylamino-7-piperidinofluoran, 2-chloro-3-(N-methyltoluidino)-7-(p-N-butylanilino)fluoran, 3,6-bis(dimethylamino)fluorenespiro(9,3′)-6′-dimethylaminophthalide, 3-(N-benzyl-N-cyclohexylamino)-5,6-benzo-7-α-napthylamino-4′-bromofluoran, 3-diethylamino-6-chloro-7-anilinofluoran, 3-N-ethyl-N-(−2-ethoxypropyl)amino-6-methyl-7-anilinofluoran, 3-N-ethyl-N-tetrahydrofurfurylamino-6-methyl-7-anilinofluoran, 3-p-dimethylaminophenyl)-3-{1,1-bis(p-dimethylaminophenyl)ethylen-2-yl}phthalide, 3-(p-dimethylaminophenyl)-3-{1,1-bis(p-dimethylaminophenyl)ethylen-2-yl}-6-dimethylaminophthalide, 3-(p-dimethylaminophenyl)-3-(1-p-dimethylaminophenyl-1-phenylethylen-2-yl)phthalide, 3-(p-dimethylaminophenyl)-3-(1-p-dimethylaminophenyl-1-p-chlorophenylethylen-2-yl)-6-dimethylaminophthalide, 3-(4′-dimethylamino-2′-methoxy)-3-(1″-p-dimethylaminophenyl-1″-p-chlorophenyl-1″,3″-butadien-4″-yl)benzophthalide, 3-(4′-dimethylamino-2′-benzyloxy)-3-(1″-p-dimethylaminophenyl-1″-phenyl-1″,3″-butadien-4″-yl)benzophthalide, 3-dimethylamino-6-dimethylamino-fluorene-9-spiro-3′-(6′-dimethylamino)phthalide, 3,3-bis(2-(p-dimethylaminophenyl)-2-p-methoxyphenyl)ethenyl)-4,5,6,7-tetrachlorophthalide, 3-bis {1,1-bis(4-pyrrolidinophenyl)ethylen-2-yl}-5,6-dichloro-4,7-dibromophthalide, bis(p-dimethylaminostyryl)-1-naphthalenesulfonylmethane, and bis(p-dimethylaminostyryl)-1-p-tolylsulfonylmethane. These compounds may be used alone or in combination.

—Reversible Color Developer—

The reversible color developer is not particularly limited and may be appropriately selected depending on the intended purpose, so long as it can be reversibly colored and decolored using heat. Suitable example of the reversible color developer includes a compound containing at least one of (1) a structure having an ability of coloring the leuco dye (e.g., a phenolic hydroxyl group, a carboxyl group, and a phosphoric acid group) and (2) a structure for controlling aggregation force between molecules (e.g., a structure linked with a straight chain hydrocarbon group) in a molecule thereof. Note that, the straight chain hydrocarbon group may be linked via a bivalent or higher linking group containing a hetero atom, and the straight chain hydrocarbon group itself may contain at least one of the linking group as described above and an aromatic group.

The (1) structure having an ability of coloring the leuco dye is not particularly limited and may be appropriately selected depending on the intended purpose, but is preferably phenol.

The (2) structure for controlling aggregation force between molecules is not particularly limited and may be appropriately selected depending on the intended purpose, but is preferably the structure linked with a straight chain hydrocarbon group.

The straight chain hydrocarbon group contains preferably 8 or more carbon atoms, more preferably 11 or more carbon atoms. The straight chain hydrocarbon group contains preferably 40 or less carbon atoms, more preferably 30 or less carbon atoms.

Among the reversible color developers, a phenolic compound represented by the following General Formula (1) is preferable, and a phenolic compound represented by the following General Formula (2) is more preferable.

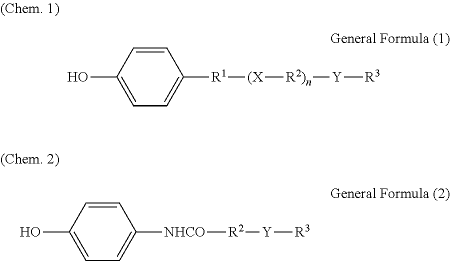

In the General Formula (1), R¹ denotes a single bond or an aliphatic hydrocarbon group containing from 1 through 24 carbon atoms.

In the General Formulae (1) and (2), R² denotes an aliphatic hydrocarbon group containing 2 or more carbon atoms, preferably 5 or more carbon atoms, more preferably 10 or more carbon atoms. The aliphatic hydrocarbon group containing 2 or more carbon atoms optionally contains a substituent.

In the General Formulae (1) and (2), R³ denotes an aliphatic hydrocarbon group containing from 1 through 35 carbon atoms, preferably from 6 through 35 carbon atoms, more preferably from 8 through 35 carbon atoms.

The reversible color developers having different structures depending on differences in R¹, R², and R³ in the General Formulae (1) and (2) may be used alone or in combination.

The sum of the numbers of carbon atoms contained in the R¹, the R², and the R³ is not particularly limited and may be appropriately selected depending on the intended purpose. The lower limit thereof is preferably 8 or more, more preferably 11 or more. The upper limit thereof is preferably 40 or less, more preferably 35 or less. The sum of the numbers of carbon atoms falling within the above described preferable range is advantageous in that stability of coloring and a decoloring property can be kept.

The aliphatic hydrocarbon group may be may be straight-chained or branch-chained, and may contain an unsaturated bond. However, preferable is a straight-chained aliphatic hydrocarbon group.

Examples of the substituent to be attached to the aliphatic hydrocarbon group include a hydroxyl group, a halogen atom, and an alkoxy group.

In the General Formulae (1) and (2), X and Y denote a bivalent group containing an N atom or an O atom, and may be the same as or different from each other.

Examples of the X and the Y include an oxygen atom, an amide group, a urea group, a diacyl hydrazine group, a diamide oxalate group, and an acylurea group. Of these, the amide group and the urea group are preferable.

In the General Formula (1), n denotes an integer of 0 or 1.

The reversible color developer is preferably used in combination with a compound containing at least one of a —NHCO— group and an —OCONH— group in a molecule thereof as a decoloration accelerator. This is because use of these compounds in combination can induce an intermolecular interaction between the decoloration accelerator and the reversible color developer in the process for shifting toward the decolored state, to thereby improve a coloring and decoloring property. The decoloration accelerator is not particularly limited and may be appropriately selected depending on the intended purpose.

The thermoreversible recording medium according to the present invention preferably further contains a photothermal converting material, and more preferably contains the photothermal converting material in the thermoreversible recording layer.

—Photothermal Converting Material—

The photothermal converting material absorbs laser light to generate heat. The photothermal converting material is preferably contained in the thermoreversible recording layer in an amount depending on light absorption rate at a wavelength of the laser light.

The light absorption rate at a wavelength of the laser light of the photothermal converting material is not particularly limited and may be appropriately selected depending on the intended purpose.

Note that, at a low light absorption rate, it is necessary to increase the irradiating energy of the laser light or to decrease the scanning velocity. Thus, the apparatus has to be upsized or the image processing speed has to be decreased. In this case, when the irradiating energy of the laser light is low, poor coloring density of a recorded image or image erasing failure may be caused.

On the other hand, at a high light absorption rate, when the irradiating energy of the laser light is excessively increased, a white void may be caused due to excessive heating or coloring may occur in spite of a discoloring operation.

An amount of the photothermal converting material contained in the thermoreversible recording layer is not particularly limited and may be appropriately selected depending on the intended purpose. When the amount is increased, an image recorded on the thermoreversible recording medium may be decreased in contrast.

The photothermal converting material is roughly classified into an inorganic material and an organic material.

Examples of the inorganic material include carbon black; metal, semimetal, and alloy thereof; metal boride, and metal oxide. These may be used alone or in combination. These are shaped in a layered form by a vacuum vapor deposition method or by adhering a particulate material with, for example, a resin.

Examples of the metal include Ge, Bi, In, Te, Se, and Cr.

Examples of the metal boride and the metal oxide include hexaboride, a tungsten oxide compound, antimony-doped tin oxide (ATO), tin-doped indium oxide (ITO), and zinc antimonate.

Example of the hexaboride includes lanthanum hexaboride (LaB₆).

The organic material may be appropriately selected from various dyes depending on a wavelength of laser light to be absorbed. In the case where a laser diode is used as a light source, a near infrared-absorbing pigment having an absorption peak at a wavelength in a range of from 700 nm through 1,600 nm is used.

Examples of the near infrared-absorbing pigment include a cyanine pigment, a quinone pigment, a quinoline derivative of indonaphthol, a phenylenediamine nickel complex, and a phthalocyanine compound. These may be used alone or in combination. Of these, the phthalocyanine compound is preferable from the viewpoints of excellent heat resistance durability for repeated image processing.

The photothermal converting material is preferably contained in the thermoreversible recording layer, but a photothermal converting layer containing the photothermal converting material may be disposed adjacent to the thermoreversible recording layer. In the where the photothermal converting layer is disposed, the photothermal converting material may also be contained in the thermoreversible recording layer.

In the where the photothermal converting layer is disposed, a barrier layer may be disposed between the thermoreversible recording layer and the photothermal converting layer for the purpose of suppressing interaction between the thermoreversible recording layer and the photothermal converting layer.

The barrier layer is not particularly limited and may be appropriately selected depending on the intended purpose, but preferably contains a highly heat conductive material.

The photothermal converting layer may contain a binder resin in addition to the photothermal converting material.

The binder resin is not particularly limited and may be appropriately selected depending on the intended purpose, so long as it can hold the photothermal converting material. As the binder resin, those used for the thermoreversible recording layer may be suitably used. Examples thereof include a thermoplastic resin, a thermosetting resin, and a UV-curable resin. Of these, preferable is the thermosetting resin curable by heat, UV rays, or electron beams from the viewpoint of improvement in durability for repeated image rewriting processing, and more preferable is a thermally cross-linkable resin cross-linked using an isocyanate compound as a cross-linking agent.

—Other Components—

The thermoreversible recording layer may contain a binder resin; and, if necessary, further contain various additives for improving or controlling coatability or a coloring and decoloring property of the thermoreversible recording layer. Examples of the additives include a surfactant, a conducting agent, filler, an antioxidant, a photostabilizer, a coloring stabilizer, and a decoloring accelerator.

—Binder Resin—

The binder resin is not particularly limited and may be appropriately selected depending on the intended purpose, so long as it can bind the thermoreversible recording layer on the support. Conventionally known resins (e.g., the thermoplastic resin, the thermosetting resin, and the UV-curable resin) can be used alone or in combination as the binder resin. Of these, preferable is a resin curable by heat, UV rays, or electron beams from the viewpoint of improvement in durability for repeated use, and more preferable is the thermosetting resin cross-linked using an isocyanate compound as a cross-linking agent.

An amount of the binder resin contained in the thermoreversible recording layer is preferably in a range of from 0.1 parts by mass through 10 parts by mass relative to 1 part by mass of the leuco dye. The amount falling within the above described preferable range is advantageous in that the thermoreversible recording layer can have satisfactory heat intensity and the coloring density can be kept.

The cross-linking agent is not particularly limited and may be appropriately selected depending on the intended purpose. Examples thereof include isocyanates, an amino resin, a phenolic resin, amines, and an epoxy compound. Of these, preferable are the isocyanates, and more preferable is a polyisocyanate compound containing a plurality of isocyanate groups.

An amount of the cross-linking agent relative to that of the binder resin is preferably an amount so that a ratio of the number of functional groups in the cross-linking agent to the number of active groups in the binder resin is in a range of from 0.01 through 2. The ratio falling within the above described preferable range is advantageous in that the heat intensity can be kept and good coloring and decoloring properties can be achieved. A catalyst used for this type of reaction may be used as a cross-linking accelerator.

A gel content of a thermally cross-linkable resin is preferably 30% or higher, more preferably 50% or higher, particularly preferably 70% or higher. The gel content falling within the above described preferable range is advantageous in that a satisfactory cross-linked state can be achieved and durability can be kept.

The cross-linked state and an uncross-linked state of the binder resin can be distinguished by immersing a coating film containing the binder resin in a high-solvency solvent. That is, the binder resin in the uncross-linked state is dissolved in the solvent without remaining in a solute.

A method for forming the thermoreversible recording layer is not particularly limited and may be appropriately selected depending on the intended purpose. Suitable examples thereof include (1) a method in which a coating liquid for the thermoreversible recording layer, which contains the binder resin, the leuco dye, and the reversible color developer dissolved or dispersed in the solvent, is applied onto the support, and the binder resin is cross-linked at the same time when or after the solvent is evaporated to shape the coating liquid into a sheet; and (2) a method in which a coating liquid for the thermoreversible recording layer, which contains the binder resin dissolved in the solvent, and the leuco dye and the reversible color developer dispersed in the solvent, is applied onto the support, and the binder resin is cross-linked at the same time when or after the solvent is evaporated to shape the coating liquid into a sheet. Note that, in the above described methods, the thermoreversible recording medium can be shaped into a sheet without using the support.

The solvent used for the above described methods cannot be uniquely defined since it depends on, for example, types of the binder resin, the leuco dye, and the reversible color developer. Examples thereof include tetrahydrofuran, methyl ethyl ketone, methyl isobutyl ketone, chloroform, carbon tetrachloride, ethanol, toluene, and benzene. Note that, the reversible color developer exists as a particulate form dispersed in the thermoreversible recording layer.

The coating liquid for the thermoreversible recording layer may contain various pigments, an antifoaming agent, a pigment, a dispersing agent, a slipping agent, a preservative, a cross-linking agent, and a plasticizer, for the purpose of allowing it to exhibit high performance as a coating material.

Examples of a coating method include a blade coating, a wire bar coating, a spray coating, an air knife coating, a bead coating, a curtain coating, a gravure coating, a kiss coating, a reverse roll coating, a dip coating, and a die coating.

An average thickness of the thermoreversible recording layer is not particularly limited and may be appropriately selected depending on the intended purpose, but, for example, is preferably in a range of from 1 micrometer through 20 micrometers, more preferably in a range of from 3 micrometers through 18 micrometers. The average thickness falling within the above described preferable range is advantageous in that an increased coloring density results in high image contrast and that the coloring density can be stabilized since heat can be prevented from dissipating within the layer and a discolored portion without reaching the coloring temperature is less likely to occur.

<Support>

A shape, structure, and size of the support are not particularly limited and may be appropriately selected depending on the intended purpose. Examples of the shape include a plate shape.

The structure may be a single layer structure or a laminate structure.

The size may be appropriately selected depending on, for example, the size of the thermoreversible recording medium.

Examples of a material for the support include an inorganic material and an organic material. These may be used alone or in combination.

Examples of the inorganic material include glass, quartz, silicon, silicon oxide, aluminium oxide, SiO₂, and metal.

Examples of the organic material include a film made of paper, a cellulose derivative (e.g., cellulose triacetate), synthetic paper, polycarbonate, polystylene, polymethyl methacrylate, or polyester. These may be used alone or in combination. Of these, preferable is a film made of polycarbonate, polymethyl methacrylate, or polyester, and more preferable is a film made of polyester.

The support is preferably surface-modified through a corona discharge treatment, an oxidization reaction treatment (e.g., with chromic acid), an etching treatment, an easy adhesion treatment, or an anticharging treatment for the purpose of improving an adhesive property.

The support is preferably whitened by adding a white pigment (e.g., titanium oxide).

An average thickness of the support is not particularly limited and may be appropriately selected depending on the intended purpose, but is preferably in a range of from 10 micrometers through 2,000 micrometers, more preferably in a range of from 20 micrometers through 1,000 micrometers.

<Other Layers>

Examples of other layers include an oxygen barrier layer, a light barrier layer, an adhesion layer or a bonding layer, a protective layer, an intermediate layer, an under layer, a back layer, an adhesive layer or a bonding agent layer, and a colored layer.

Note that, other layers such as the intermediate layer, the protective layer, the adhesive layer or the bonding agent layer may be disposed between the oxygen barrier layer and the thermoreversible recording layer.

<<Oxygen Barrier Layer>>

The oxygen barrier layer is not particularly limited and may be appropriately selected depending on the intended purpose, so long as it can prevent oxygen from entering the thermoreversible recording layer to prevent an image from remaining unerased due to photodeterioration of the leuco dye in the thermoreversible recording layer or to prevent a background from coloring. The oxygen barrier layers are preferably disposed on top and bottom surfaces of the thermoreversible recording layer in order to effectively prevent oxygen from entering the thermoreversible recording layer. Note that, the oxygen barrier layers disposed on top and bottom surfaces of the thermoreversible recording layer may be the same as or different from each other.

An oxygen permeability in the oxygen barrier layer at 25 degrees Celsius and 80% RH is preferably 20 mL/(m² day MPa) or less, more preferably 5 mL/(m² day MPa) or less, particularly preferably 1 mL/(m² day MPa) or less. The oxygen permeability falling within the above described preferable range is advantageous in that oxygen can be sufficiently shielded and the leuco dye is less likely to be photodeteriorated to thereby prevent an image from remaining unerased. Note that, the oxygen permeability depends on an environmental temperature or environmental humidity. Therefore, the oxygen permeability is preferably low not only under the condition of 25 degrees Celsius and 80% RH, but also under a high temperature and high humidity condition (e.g., 30 degrees Celsius and 80% RH or 35 degrees Celsius and 80% RH).

The oxygen permeability can be measured according to, for example, JIS K7126B (isopiestic method) or ATSMD 3985. A measuring device of the oxygen permeability may be oxygen permeability measuring devices OX-TRAN 2/21 or OX-TRAN 2/61 (manufactured by MOCON Inc.), or MODEL 8001 (manufactured by Systech Instruments Ltd.).

A water-soluble resin (e.g., polyvinyl alcohol or an ethylene-polyvinyl alcohol copolymer) exhibits excellent oxygen shielding property at low humidity when used as a material of the oxygen shielding material. However, the material absorbs water at increased ambient humidity due to its hydrophilicity, resulting in significantly decreased oxygen shielding property. As a result, satisfactory oxygen shielding property may not be achieved in the case of outdoor use in highly humid summer. Therefore, an inorganic vapor-deposited layer formed of an inorganic oxide (e.g., silica or alumina) or an inorganic vapor-deposited film in which an inorganic oxide is vapor-deposited on a polymer film (e.g., polyethylene terephthalate (PET) or nylon) such as a silica vapor-deposited film, an alumina vapor-deposited film, and a silica/alumina vapor-deposited film, which has the oxygen permeability of 20 mL/(m² day MPa) or less at 25 degrees Celsius and 80% RH, is preferably used. Of these, the silica vapor-deposited film is more preferable since it is inexpensive, has a high oxygen shielding property, and is less effective against a temperature and humidity. The polyethylene terephthalate (PET) is preferably used for a base of the inorganic vapor-deposited film from the viewpoints of suitability for vapor deposition, oxygen shielding stability, and heat resistance.

A method for forming the oxygen barrier layer is not particularly limited and may be appropriately selected depending on the intended purpose. For example, the oxygen barrier layer may be formed by commonly used methods such as a coating method and a laminate method. In the case of forming only the inorganic vapor-deposited layer as the oxygen barrier layer, for example, a PVD method or a CVD method may be used for vapor deposition.

An average thickness of the oxygen barrier layer is not particularly limited and may be appropriately selected depending on the intended purpose, but is preferably in a range of from 0.005 micrometers through 1,000 micrometers, more preferably in a range of from 0.007 micrometers through 500 micrometers. The average thickness falling within the above described preferable range is advantageous in transparency and stable coloring density. In the case of using the inorganic vapor-deposited layer or the inorganic vapor-deposited film as the oxygen barrier layer, the average thickness is preferably in a range of from 5 nm through 100 nm, more preferably in a range of from 7 nm through 80 nm. The average thickness falling within the above described preferable range is advantageous in that oxygen can be satisfactorily shielded, transparency can be kept, and coloring can be prevented.

<<Light Barrier Layer>>

The light barrier layer is not particularly limited and may be appropriately selected depending on the intended purpose, so long as it has an average light transmittance of light having a wavelength in a range of from 300 nm through 400 nm of 5% or less and an average light transmittance of light having a wavelength in a range of from 380 nm through 495 nm of 20% or less. The light barrier layer may have a single layer structure or a laminate structure comprised of a Ultraviolet barrier layer and a blue light barrier layer described below.

In the case of the laminate structure, the order of laminating the Ultraviolet barrier layer and the blue light barrier layer is not particularly limited and may be appropriately selected depending on the intended purpose. For example, in the case where a material of the blue light barrier layer is desirably protected from UV rays, the Ultraviolet barrier layer is preferably disposed on a surface layer side of the thermoreversible recording medium. In the case where the blue light barrier layer serving also as the protective layer is deposited on the surface layer side of the thermoreversible recording medium, the number of layers can be decreased, leading to improved productivity.

The Ultraviolet barrier layer may be adjacent to the blue light barrier layer, or another layer such as the oxygen barrier layer may be deposited between the Ultraviolet barrier layer and the blue light barrier layer.

The light barrier layer can be measured for the light transmittance as follows.

The thermoreversible recording medium is formed by disposing a nontransparent layer (e.g., the thermoreversible recording layer) on a nontransparent support, laminating the light barrier layer on the nontransparent layer, and laminating other layers (e.g., the protective layer) on the light barrier layer. The nontransparent support is peeled off by gradually scraping with the edge of a cutter knife. Then, the nontransparent layer (e.g., the thermoreversible recording layer) is gradually scraped with the edge of a cutter knife or sandpaper from a back side of the thermoreversible recording medium to remove the support and the nontransparent layer (e.g., the thermoreversible recording layer). A spectrophotometer (U-4100, manufactured by Hitachi High-Technologies Corporation) is used to measure the light transmittance at a wavelength in a range of from 300 nm through 700 nm by 1 nm. The resultant light transmittances at each wavelength are averaged to determine the average light transmittance of light having a wavelength in a range of from 380 nm through 495 nm and the average light transmittance of light having a wavelength in a range of from 300 nm through 400 nm.

Note that, the light barrier layer has preferably the average light transmittance of light having a wavelength in a range of from 300 nm through 400 nm of 5% or less, more preferably 3% or less, particularly preferably 1% or less from the viewpoint of prevention of photodeterioration of the leuco dye in the thermoreversible recording layer.

The light barrier layer contains a binder resin and a compound absorbing, reflecting, or scattering light having a wavelength of 500 nm or less; and, if necessary, further contains other components such as filler or a lubricant. The light barrier layer may also serve as the protective layer.

—Binder Resin—

The binder resin is not particularly limited and may be appropriately selected depending on the intended purpose. Examples thereof include the thermoplastic resin, the thermosetting resin, and the UV-curable resin described above for the thermoreversible recording layer.

Examples of the binder resin include polyethylene, polypropylene, polystylene, polyvinyl alcohol, polyvinyl butyral, polyurethane, saturated polyester, unsaturated polyester, an epoxy resin, a phenolic resin, polycarbonate, polyamide, acrylic polyol, polyester polyol, and polyurethane polyol. These may be used alone or in combination.

The binder resin may be cross-linked using a cross-linking agent.

The cross-linking agent is not particularly limited and may be appropriately selected depending on the intended purpose. Examples thereof include isocyanates, an amino resin, a phenolic resin, amines, and an epoxy compound. Of these, preferable are isocyanates, particularly preferable is a polyisocyanate compound containing a plurality of isocyanate groups.

An amount of the cross-linking agent relative to that of the binder resin is preferably an amount so that a ratio of the number of functional groups in the cross-linking agent to the number of active groups in the binder resin is in a range of from 0.01 through 2.

—Compound Absorbing, Reflecting, or Scattering Light of Wavelength of 500 nm or Less—

The compound absorbing, reflecting, or scattering light of a wavelength of 500 nm or less can be an organic compound or an inorganic compound. A polymer having a structure that absorbs light having a wavelength of 500 nm or less at a main chain or a side chain of the polymer can be used, which can be served as a binder resin.

The compound absorbing, reflecting, or scattering light of a wavelength of 500 nm or less can be an organic compound or an inorganic compound so long as it is yellowish compound. When the compound is used over a long period, a yellowish pigment excellent in durability to light or heat is preferably used, but a pigment and a dye can be each used. Examples thereof include a quinophthalone compound, an isoindolin compound, an isoindolinone compound, an anthraquinone compound, an azo-compound, a disazo-compound, a benzimidazolone compound, and a complex oxide pigment. Among them, a quinophthalone compound, an isoindolin compound, an isoindolinone compound, an anthraquinone compound, an azo-compound, a disazo-compound, and a benzimidazolone compound are preferable.

Examples of the quinophthalone compound include Pigment Yellow 138.

Examples of the isoindolin compound include Pigment Yellow 139.

Examples of the isoindolinone compound include Solvent Yellow 163 and Solvent Yellow 167.

Examples of the anthraquinone compound include Pigment Yellow 109, Pigment Yellow 110, Pigment Yellow 137, and Pigment Yellow 173.

Examples of the azo compound and the disazo compound include Pigment Yellow 17, Pigment Yellow 55, Pigment Yellow 83, Pigment Yellow 169, Pigment Yellow 180, and Solvent Orange 54.

Examples of the benzimidazolone compound include Pigment Yellow 120, Pigment Yellow 151, Pigment Yellow 154, and Pigment Yellow 175.

Examples of the complex oxide pigment include Pigment Yellow 53, Pigment Yellow 157, Pigment Yellow 158, Pigment Yellow 160, and Pigment Yellow 184.

In the case where the compound absorbing, reflecting, or scattering light of a wavelength of 500 nm or less insufficiently absorbs, reflects, or scatters light of a wavelength of from 300 nm through 400 nm, it can be used in combination with the conventional ultraviolet rays barrier materials.

Examples of the conventional ultraviolet rays barrier materials include an organic ultraviolet rays barrier material, an organic ultraviolet absorber, and an inorganic ultraviolet rays barrier material.

Examples of the organic ultraviolet rays barrier material include a benzotriazole ultraviolet absorber, a benzophenone ultraviolet absorber, a salicylate ester ultraviolet absorber, a cyanoacrylate ultraviolet absorber, and a cinnamic acid triazine ultraviolet absorber. Among them, a benzotriazole ultraviolet absorber and a cinnamic acid triazine ultraviolet absorber are preferable, an ultraviolet absorber in which the hydroxyl group is protected by bulky functional group(s) is particularly preferable.

Examples of the organic ultraviolet absorber include 2-(2′-hydroxy-3′,5′-di-t-butylphenyl)benzotriazole, 2-(2′-hydroxy-3′-t-butyl-5′-methylphenyl)benzotriazole, 2-(2′-hydroxy-3′,5′-di-t-butylphenyl)-5-chlorobenzotriazole, 2-(2′-hydroxy-3′-t-butyl-5′-methylphenyl)-5-chlorobenzotriazole, 2-(2′-hydroxy-5′-t-octylphenyl)benzotriazole, 2,2′-methylenebis[6-2H-benzotriazol-2-yl]-4-(1,1,3,3-tetramethylbutyl)phenol]), 6,6′,6″-(1,3,5-triazine-2,4,6-triyl)tris(3-hexyloxy-2-methylphenol), and 2-(4,6-diphenyl-1,3,5-triazin-2-yl)-5-[2-(2-ethylhexanoyloxy)ethoxy]phenol. Moreover, when the ultraviolet absorber is used over a long period, the ultraviolet absorber may be a copolymerized polymer of, for example, acrylic resins and stylene resins, provided with a pendant group, where the copolymerized polymer contains a skeleton having ability to absorb the ultraviolet rays; or a product obtained by coating the surface of an inorganic material (e.g., talc) with an organic ultraviolet absorber, and treating the surface with dimethicone, in order to prevent the ultraviolet absorber from aggregation or bleeding.

The inorganic ultraviolet rays barrier material is suitably a metal compound having an average particle diameter of 100 nm or less. Examples thereof include: metallic oxide or complex oxide thereof (e.g., zinc oxide, indium oxide, alumina, silica, zirconia oxide, tin oxide, cerium oxide, iron oxide, antimony oxide, barium oxide, calcium oxide, titanium oxide, bismuth oxide, nickel oxide, magnesium oxide, chromium oxide, manganese oxide, tantalum oxide, niobium oxide, thorium oxide, hafnium oxide, molybdenum oxide, ferrous ferrite, nickel ferrite, cobalt ferrite, barium titanate, and potassium titanate); metallic sulfide or a sulfate compound (e.g., zinc sulfide and barium sulfate); metallic carbide (e.g., titanium carbide, silicon carbide, molybdenum carbide, tungsten carbide, and tantalum carbide); and metallic nitride (e.g., aluminum nitride, silicon nitride, boron nitride, zirconium nitride, vanadium nitride, titanium nitride, niobium nitride, and gallium nitride). Among them, ultrafine particles of metallic oxide are preferable, silica, alumina, zinc oxide, titanium oxide, cerium oxide, and bismuth oxide are more preferable. The surface of these compounds can be treated with silicon, wax, organic silane, or silica.

An amount of the compound absorbing, reflecting, or scattering light of a wavelength of 500 nm or less is preferably in a range of from 1% by mass through 95% by mass relative to the total amount of light barrier layer.

A solvent used for a coating liquid of the light barrier layer, an apparatus for dispersing the coating liquid, a coating method, and a curing method are not particularly limited and may be appropriately selected depending on the intended purpose.

An average thickness of the light barrier layer is preferably in a range of from 0.1 micrometers through 30 micrometers, more preferably in a range of from 0.5 micrometers through 20 micrometers.

An average transmittance of light of a wavelength of from 380 nm through 495 nm in the light barrier layer is 20% or less, preferably 10% or less, more preferably 5% or less, by adjusting the amount of the compound absorbing, reflecting, or scattering light of a wavelength of 500 nm or less, or an average thickness of the light barrier layer. Therefore, the aforementioned adjustments make it possible to prevent a metal oxide absorbing light of the near infrared region from increasing absorption of light of the near infrared region upon light irradiation.

Moreover, in the case where the metal oxide absorbing light of the near infrared region is contained in the same layer as the layer of the leuco dye, even if an average transmittance of light of a wavelength of from 380 nm through 495 nm in the light barrier layer is 10% or less, a coloring of the metal oxide may be caused through long-term irradiation of light (e.g., sunlight), when a transmittance of light of a wavelength of 470 nm in the light barrier layer is more than 10%. The metal oxide absorbing light of the near infrared region and the leuco dye exist simultaneously to cause the aforementioned phenomenon. In general, a leuco dye before reaction with a color developer has no absorption in a wavelength range of 420 nm through 430 nm. Therefore, the aforementioned phenomenon is unpredictable. In order to improve this phenomenon, it is necessary to adequately block light at a longer side of a wavelength, and transmittance of light of a wavelength of 470 nm in the light barrier layer is preferably 10% or less, more preferably 5% or less.

An average transmittance of light of a wavelength of from 600 nm through 700 nm in the light barrier layer is preferably 80% or more. When a bar code recorded on the thermoreversible recording medium is read, the light barrier layer easily preferably transmits light of a wavelength of around 650 nm, because red light of a wavelength of around 650 nm is used for the conventional bar code readers. As a result, contrast to an image recorded on the thermoreversible recording medium is sufficiently attained to obtain good property of reading a bar code.

<<<Blue Light Barrier Layer>>>

The blue light barrier layer contains a binder resin and a compound absorbing, reflecting, or scattering light of a wavelength of 500 nm or less, and further contains other components such as filler and a lubricant, if necessary. Here, “blue light” means blue light of a wavelength of from 380 nm through 495 nm in visible rays.

—Binder Resin—

The binder resin is not particularly limited and may be appropriately selected depending on the intended purpose. Examples of the binder resin include a binder resin, a thermoplastic resin, and a thermosetting resin as described for the thermoreversible recording layer. Suitable examples thereof include polyethylene, polypropylene, polystyrene, polyvinyl alcohol, polyvinyl butyral, polyurethane, saturated polyester, unsaturated polyester, an epoxy resin, a phenol resin, polycarbonate, polyamide, acrylic polyol, polyester polyol, and polyurethane polyol. The binder resin may be cross-linked by a cross-linking agent. The same binder resin as described for the thermoreversible recording layer can be suitably used. The binder resin may contain other components such as filler.

—Compound Absorbing, Reflecting, or Scattering Light of Wavelength of 500 nm or Less—

The compound absorbing, reflecting, or scattering light of a wavelength of 500 nm or less as described for the light barrier layer can be used as the compound absorbing, reflecting, or scattering light of a wavelength of 500 nm or less in the blue light barrier layer.

An amount of the compound absorbing, reflecting, or scattering light of a wavelength of 500 nm or less is preferably in a range of from 1% by mass through 95% by mass relative to the total amount of the blue light barrier layer.

A solvent used for a coating liquid of the blue light barrier layer, an apparatus for dispersing the coating liquid, a coating method, and a curing method are not particularly limited and may be appropriately selected depending on the intended purpose.

An average thickness of the blue light barrier layer is preferably in a range of from 0.1 micrometers through 30 micrometers, more preferably in a range of from 0.5 micrometers through 20 micrometers.

The method for measuring transmittance of the light barrier layer can be used for a method for measuring transmittance of the blue light barrier layer.

<<<Ultraviolet Rays Barrier Layer>>>

The ultraviolet rays barrier layer is preferably disposed on the surface of the support opposite to the surface of the support on which the thermoreversible recording layer is provided, in order that the resin component in the thermoreversible recording layer is prevented from deterioration through ultraviolet rays, or that the leuco dye is prevented from a coloring caused through ultraviolet rays, and erasing residue caused by photodegradation.

The ultraviolet rays barrier layer can be additionally can be disposed on the surface of the light barrier layer in order to prevent the constituent materials in the light barrier layer from discoloration and photodecradation.

The ultraviolet rays barrier layer contains an ultraviolet rays barrier material, and further contains other components such as a binder resin, filler, a lubricant, and a colored pigment, if necessary.

—Ultraviolet Rays Barrier Material—

The ultraviolet rays barrier material as described for the light barrier layer can be used for the ultraviolet rays barrier material of the ultraviolet rays barrier layer.

An amount of the ultraviolet rays barrier material is preferably in a range of from 1% by mass through 95% by mass relative to the total amount of the ultraviolet rays barrier layer, when an organic ultraviolet absorber is contained therein. The amount thereof is preferably in a range of from 1% by volume through 95% by volume in terms of volume fraction when an inorganic ultraviolet absorber is contained therein. Note that, the thermoreversible recording layer may contain these organic and inorganic ultraviolet rays barrier materials.

—Binder Resin—

The binder resin is not particularly limited, and examples of the binder resin include a resin component such as a binder resin, a thermoplastic resin, and a thermosetting resin as described for the thermosensitive recording layer. Suitable examples thereof include polyethylene, polypropylene, polystyrene, polyvinyl alcohol, polyvinylbutyral, polyurethane, saturated polyester, unsaturated polyester, an epoxy resin, a phenol resin, polycarbonate, polyamide, acrylic polyol, polyester polyol, and polyurethane polyol.

An ultraviolet-rays-absorbing polymer may be used, and may be cross-linked by a cross-linking agent. The same materials as used for the recording layer or the protective layer may be suitably used. If necessary, the ultraviolet rays barrier layer may contain other components such as filler.

An average thickness of the ultraviolet rays barrier layer is preferably in a range of from 0.1 micrometers through 30 micrometers, more preferably in a range of from 0.5 micrometers through 20 micrometers.

A solvent used for a coating liquid of the ultraviolet rays barrier layer, an apparatus for dispersing the coating liquid, a method for coating the ultraviolet rays barrier layer, and a method for curing the ultraviolet rays barrier layer can be the same conventional methods as used for the thermosensitive recording layer.

The method for measuring transmittance of the light barrier layer can be used for a method for measuring transmittance of the ultraviolet rays barrier layer. Moreover, when the light barrier layer is formed by superimposing the blue light barrier layer and the ultraviolet rays barrier layer on top of one another, the same method as used in the method for measuring the transmittance of the light barrier layer can be used in a state that the blue light barrier layer and the ultraviolet rays barrier layer are superimposed on top of one another.

<<Adhesion Layer or Bonding Layer>>

An adhesion layer or a bonding layer may be disposed between the oxygen barrier layer and an underlying layer.

A method for forming the adhesion layer or the bonding layer is not particularly limited, and examples of the method include a usual coating method and a usual laminate method.

An average thickness of the adhesion layer or the bonding layer is not particularly limited and may be appropriately selected depending on the intended purpose. It is preferably in a range of from 0.1 micrometers to 20 micrometers.

A material of the adhesion layer or the bonding layer is not particularly limited and may be appropriately selected depending on the intended purpose. Examples of the material include urea resins, melamine resins, phenolic resins, epoxy resins, vinyl acetate resins, vinyl acetate-acrylic copolymers, ethylene-vinyl acetate copolymers, acrylic resins, polyvinyl ether resins, vinyl chloride-vinyl acetate copolymers, polystyrene resins, polyester resins, polyurethane resins, polyamide resins, chlorinated polyolefin resins, polyvinyl butyral resins, acrylate copolymers, methacrylate copolymers, natural rubbers, cyanoacrylate resins, and silicone resins. These materials may be cross-linked by a cross-linking agent. The material of the adhesion layer or the bonding layer may be of a hot-melt type.

Moreover, two or more inorganic deposited films are laminated, and thus oxygen barrier property can be improved. In the case where the inorganic deposited films are laminated, the adhesion layer or the bonding layer can be used for bonding the inorganic deposited films. The adhesion layer or the bonding layer may contain the compound absorbing, reflecting, or scattering light of a wavelength of 500 nm or less.

Here, a method for determining whether the thermoreversible recording medium has the oxygen barrier layer can be determined by measuring oxygen transmittance of the thermoreversible recording medium using an oxygen transmittance measuring device. Namely, when the oxygen transmittance of the thermoreversible recording medium is 20 mL/(m² day MPa) or less, it can be judged that the thermoreversible recording medium has the oxygen barrier layer.

<<Protective Layer>>

The thermoreversible recording medium for use in the present invention preferably includes a protective layer disposed on the thermoreversible recording layer for the purpose of protecting the thermoreversible recording layer. The protective layer is not particularly limited and may be appropriately selected depending on the intended purpose. The protective layer may be disposed on one or more layers, but is preferably disposed on an externally exposed outermost surface of the thermoreversible recording medium.

The protective layer includes a binder resin, and if necessary, includes other components such as a release agent and filler. The binder resin of the protective layer is not particularly limited and may be appropriately selected depending on the intended purpose. Examples of the binder resin include thermally cross-linkable resins, thermosetting resins, ultraviolet (UV)-curable resins, and electron-beam curable resins. Among these, UV-curable resins and thermally cross-linkable resins are preferable.

The UV-curable resin can form an extremely hard film after curing, and it is possible to suppress deformation of the recording medium caused by damages due to physical contacts on a surface thereof and laser heating. Thus, the obtained thermoreversible recording medium has superior repetition durability. Also, the thermally cross-linkable resin can harden the surface similarly but slightly inferior to the UV-curable resin, and it provides superior repetition durability.

The UV-curable resin is not particularly limited and may be appropriately selected depending on the intended purpose. Examples of the UV-curable resin include urethane acrylate oligomers, epoxy acrylate oligomers, polyester acrylate oligomers, polyether acrylate oligomers, vinyl oligomers, unsaturated polyester oligomers, and monomers such as various monofunctional or polyfunctional acrylates, various monofunctional or polyfunctional methacrylates, vinyl esters, ethylene derivatives, and allyl compounds. Among these, the polyfunctional monomers or the oligomers containing four or more functional groups are particularly preferable. By mixing two or more types of these monomers or oligomers, hardness, degree of contraction, flexibility and coating strength of the resin film may be appropriately adjusted. Also, in order to cure the monomer or the oligomer using ultraviolet rays, it is necessary to use a photopolymerization initiator or a photopolymerization accelerator.

A content of the photopolymerization initiator or the photopolymerization accelerator is preferably 0.1% by mass to 20% by mass, more preferably 1% by mass to 10% by mass with respect to the total mass of the resin components of the protective layer.

A method of ultraviolet irradiation for curing the UV-curable resin is not particularly limited and may be appropriately selected depending on the intended purpose. Examples of the method include use of an ultraviolet irradiation apparatus. The ultraviolet irradiation apparatus is equipped with, for example, a light source, lighting, a power supply, a cooling device and a conveying device.

Examples of the light source include mercury lamps, metal halide lamps, potassium lamps, mercury-xenon lamps, and flash lamps.

A wavelength of the light source may be appropriately selected depending on an UV absorption wavelength of the photopolymerization initiator and the photopolymerization accelerator added to the thermoreversible recording medium.

Conditions of the ultraviolet irradiation are not particularly limited and may be appropriately selected depending on the intended purpose. For example, a lamp power, a conveying speed, and so on may be determined depending on the irradiation energy required for curing the resin.

As the thermally cross-linkable resin, for example, those similar to the binder resin used for the thermoreversible recording layer may be favorably used. The thermally cross-linkable resin is preferably cross-linked.

As the thermally cross-linkable resin, it is preferable to use a resin containing a group reactive with a curing agent such as a hydroxyl group, an amino group, and a carboxyl group, and a polymer containing a hydroxyl group is preferable. As the curing agent, for example, the cross-linking agent similar to those used for the thermoreversible recording layer may be favorably used.

For the sake of transportability, examples of the release agent include: silicones containing a polymerizable group and silicone-grafted polymers; and waxes, zinc stearate, and silicone oil. A content of the release agent is preferably 0.01% by mass to 50% by mass, more preferably 0.1% by mass to 40% by mass with respect to the total mass of the resin components of the protective layer.

To the protective layer, a pigment, a surfactant, a leveling agent, an antistatic agent, and so on may further be added, if necessary.

When the protective layer contains the compound absorbing, reflecting, or scattering light of a wavelength of 500 nm or less, and being poor in absorbing, reflecting, or scattering light of a wavelength of from 300 nm through 400 nm, the protective layer can also serve as the blue light barrier layer because it cannot prevent ultraviolet rays necessary from curing. In that case, the number of layers can be reduced to improve productivity.

For a coating solution of the protective layer, known methods used for the thermoreversible recording layer may be used for a solvent, a dispersion apparatus of the coating solution, a coating method of the protective layer and a drying method. Here, when the UV curing resin is used, a curing step by ultraviolet irradiation is required after coating and drying, and an ultraviolet irradiation apparatus, a light source, and irradiation conditions are as described above.

An average thickness of the protective layer is preferably 0.1 micrometers to 20 micrometers, more preferably 0.5 micrometers to 10 micrometers, particularly preferably 1.5 micrometers to 6 micrometers. When the average thickness is less than 0.1 micrometers, it cannot fulfill the full function as a protective layer of the thermoreversible recording medium. As a result, the medium degrades quickly due to repeated recording by heat, and it may not be repeatedly used. When the average thickness exceeds 20 micrometers, heat from the layer containing the photothermal converting material is easily escaped to the protective layer. As a result, there are cases where image recording and image erasing by heat are difficult to perform.

<<Intermediate Layer>>

An intermediate layer is preferably disposed on the thermoreversible recording layer for the purpose of improving adhesion between the thermoreversible recording layer and the oxygen barrier layer, or smoothing a surface of the thermoreversible recording layer. The intermediate layer can improve image quality.

The intermediate layer includes a binder resin, and if necessary, further includes other components such as filler, a lubricant and a colored pigment. Moreover, the intermediate layer can contain the compound absorbing, reflecting, or scattering light of a wavelength of 500 nm or less. Furthermore, the intermediate layer may contain an ultraviolet absorber. The ultraviolet absorber may be an organic compound absorber or an inorganic compound.

The binder resin is not particularly limited and may be appropriately selected depending on the intended purpose. Resin components including the binder resin of the thermoreversible recording layer, thermoplastic resins, and thermosetting resins may be used.

An average thickness of the intermediate layer is preferably 0.1 micrometers to 20 micrometers, more preferably 0.5 micrometers to 10 micrometers. For a coating solution of the intermediate layer, known methods used for the thermoreversible recording layer may be used for a solvent, a dispersion apparatus of the coating solution, a coating method of the intermediate layer and a drying and curing method of the intermediate layer.

<<Under Layer>>

An under layer may be disposed between the thermoreversible recording layer and the support for the purpose of effectively utilizing generated heat to thereby increase sensitivity, improving adhesion between the support and the thermoreversible recording layer, or preventing permeation of a material contained in the recording layer into the support.

The under layer contains hollow particles and optionally a binder resin; and, if necessary, may further contain other components.

Examples of the hollow particles include: single-hollow particles having one hollow portion in a particle; and multi-hollow particles having a plurality of hollow portions in a particle. These may be used alone or in combination of two or more.

A material of the hollow particles is not particularly limited and may be appropriately selected depending on the intended purpose. Nonetheless, favorable examples thereof include a thermoplastic resin. The hollow particles are not particularly limited and may be appropriately produced or be commercial products. Examples of the commercial products include MICROSPHERE R-300 (manufactured by Matsumoto Yushi-Seiyaku Co., Ltd.); ROPAQUE HP1055 and ROPAQUE HP433J (both manufactured by Zeon Corporation); and SX866 (manufactured by JSR Corporation).

A content of the hollow particles in the under layer is not particularly limited and may be appropriately selected depending on the intended purpose. Nonetheless, it is preferably 10% by mass to 80% by mass, for example.

As the binder resin, the resins similar to those used for the thermoreversible recording layer or the layer including the polymer having an ultraviolet absorbing structure may be used.

The under layer may further include, if necessary, other components such as filler, a lubricant, a surfactant, and a dispersant.

Examples of the filler include an inorganic filler and an organic filler, and the inorganic filler is preferable. Examples of the inorganic filler include calcium carbonate, magnesium carbonate, titanium oxide, silicon oxide, aluminum hydroxide, kaolin and talc.

An average thickness of the under layer is not particularly limited and may be appropriately selected depending on the intended purpose. Nonetheless, it is preferably 1 micrometer to 80 micrometers, more preferably 4 micrometers to 70 micrometers, particularly preferably 12 micrometers to 60 micrometers.

<<Back Layer>>

In the present invention, the back layer may be disposed on a surface of the support opposite to a surface where the thermoreversible recording layer is disposed, for the purpose of preventing the thermoreversible recording medium from curling or charging, and improving conveyance properties of the thermoreversible recording medium.

The back layer contains a binder resin; and, if necessary, may further contain other components, such as filler, conductive filler, a lubricant, and color pigments. The binder resin is not particularly limited and may be appropriately selected depending on the intended purpose. Examples thereof include thermally cross-linkable resins, thermosetting resins, ultraviolet (UV)-curable resins, and electron-beam curable resins. Among these, ultraviolet (UV)-curable resins and thermally cross-linkable resins are particularly preferable. As the UV-curable resins, the thermally cross-linkable resins, the filler, the conductive filler, and the lubricant, those used for the thermoreversible recording layer or the protective layer may be favorably used.

<<Adhesive Layer or Bonding Agent Layer>>

In the present invention, the adhesive layer or bonding agent layer may be disposed on a surface of the support opposite to a surface where the thermoreversible recording layer is disposed, to thereby use the thermoreversible recording medium as a thermosensitive recording label. As for a material of the adhesive layer or bonding agent layer, commonly used materials can be used.

A material of the adhesive layer or the bonding agent layer is not particularly limited and may be appropriately selected depending on the intended purpose. Examples of the material include urea resins, melamine resins, phenolic resins, epoxy resins, vinyl acetate resins, vinyl acetate-acrylic copolymers, ethylene-vinyl acetate copolymers, acrylic resins, polyvinyl ether resins, vinyl chloride-vinyl acetate copolymers, polystyrene resins, polyester resins, polyurethane resins, polyamide resins, chlorinated polyolefin resins, polyvinyl butyral resins, acrylate copolymers, methacrylate copolymers, natural rubbers, cyanoacrylate resins, and silicone resin. These materials may be cross-linked by a cross-linking agent.

The material of the adhesive layer or the bonding agent layer may be of a hot-melt type. A release paper may be used, or the medium may be without a release paper. By providing the adhesive layer or the bonding agent layer, a thermoreversible recording layer may be pasted on the whole or a part of the surface of a thick substrate of a vinyl chloride card with a magnetic stripe on which application of a recording layer is difficult. Thereby, a part of information stored in the magnetic stripe may be displayed, and this medium becomes more convenient. Such a thermosensitive recording label with the adhesive layer or the bonding agent layer is also applicable to thick cards such as IC card and optical card.

<<Colored Layer>>

A colored layer may be disposed between the support and the thermoreversible recording layer of the thermoreversible recording medium for the purpose of improving visibility. The colored layer may be formed by applying and drying a solution or a dispersion liquid including a colorant and a resin binder on a target surface, or simply by pasting a colored sheet.

A color print layer may be disposed on the thermoreversible recording medium.

The thermoreversible recording medium may be used in combination with an irreversible recording layer. In this case, each irreversible recording layer has an identical or different color tone. Also, a colored layer with an arbitrary picture formed by printing such as offset printing and gravure printing or by an inkjet printer, thermal transfer printer or a sublimation printer may be disposed on a partial or an entire surface of an identical surface or a part of an opposite surface of the thermoreversible recording layer of the thermoreversible recording medium, and further an OP varnish layer composed mainly of a hardening resin may be disposed on an entire or a partial surface of the colored layer. Examples of the arbitrary picture include characters, patterns, designs, photographs and information to be detected by infrared. Also, any of the constituting layers may be colored by adding a dye or a pigment.

It is also possible to provide a hologram for security to the thermoreversible recording medium. Also, for imparting design, a design of a figure, a company emblem or a symbol mark may be provided by relief or intaglio.

The thermoreversible recording medium may be processed into a desired shape according to its use, and examples of the shape include shapes of a card, a tag, a label, a sheet and a roll.

Examples of those processed into the card shape include a prepaid card, a reward card and a credit card. A tag-shaped medium having a size smaller than the size of the card may be used for a price tag and so on. Also, a tag-shaped medium having a size larger than the size of the card may be used for process management, shipping instruction, ticket and so on. Since it may be pasted, a label-shaped medium is processed into various sizes and used for process management, commodities management and so on by pasting it on a cart, a container, a box, a container and so on which are repeatedly used. Also, the sheet having a size larger than the card has a larger image recording area, and thus it may be used as an instruction for a general document, process management.

FIG. 3 is a schematic cross-sectional view of one example of a layer configuration of the thermoreversible recording medium of the present invention.

In FIG. 3, a layer configuration of the thermoreversible recording medium 100 includes an aspect where a support 101; a thermoreversible recording layer 102 including a photothermal converting material; a first oxygen barrier layer 103; and a ultraviolet ray barrier layer 104 are disposed in this order, and a second oxygen barrier layer 105 is disposed on a surface of the support 101, where the surface does not have the thermoreversible recording layer 102 and so on. Note that, although not illustrated, a protective layer may be formed on the outermost layer.

<Image Recording and Image Erasing Mechanism>

The image recording and image erasing mechanism is an aspect that color tone changes reversibly by heat. The aspect is composed of a leuco dye and a reversible color developer (hereinafter, it may also be referred to as a “color developer”), and a color toner reversibly changes between a transparent state and a colored state by heat.

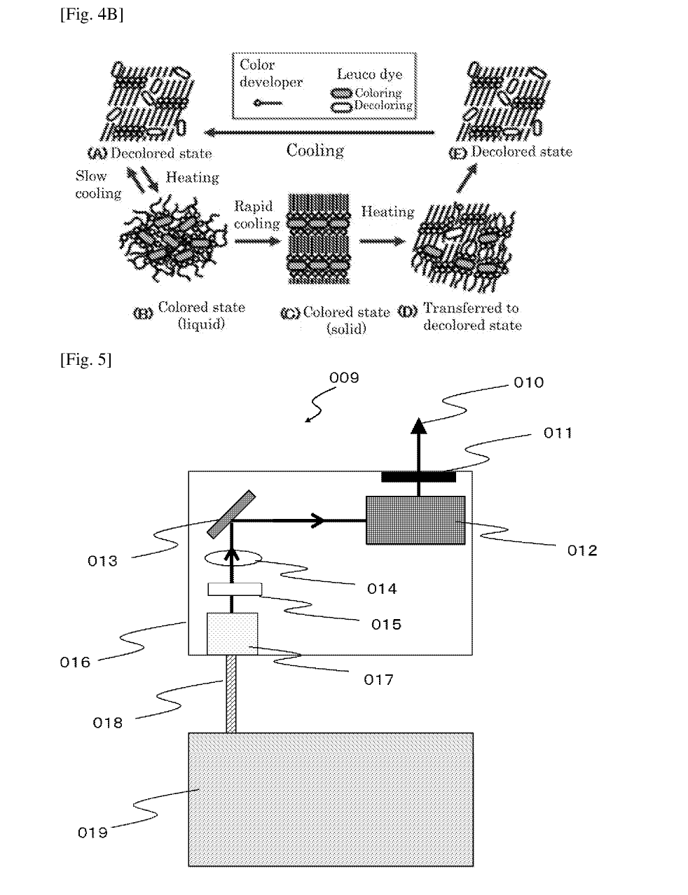

FIG. 4A illustrates one example a temperature-color density change curve of a thermoreversible recording medium including a thermoreversible recording layer which includes the leuco dye and the color developer in the resin. FIG. 4B illustrates a coloring and decoloring mechanism of the thermoreversible recording medium, where the transparent state and the colored state reversibly changes by heat.

First, as the recording layer in a decolored state (A) is heated, the leuco dye and the color developer are melt-mixed at a melting temperature T₁. It develops a color and becomes a melted and colored state (B). When it is rapidly cooled from the melted and colored state (B), it is allowed to cool to a room temperature while retaining its colored state becomes a colored state (C) with its colored state stabilized and fixed. Whether or not this colored state is obtained depends on a cooling rate from the melted state. When it is cooled slowly, decoloration occurs in the course of cooling, and it becomes the initial decolored state A or a state with a low density relative to the colored state (C) by rapid cooling. On the other hand, when it is heated again from the colored state (C), decoloration occurs at a temperature T₂, which is lower than the coloring temperature (D to E). When it is cooled from this state, it returns to the initial decolored state (A).

The colored state (C) obtained by rapid cooling from a melted state is a state where the leuco dye and the color developer are mixed while they as molecules may contact and react one another, and in many cases, it forms a solid state. In this state, a melt mixture of the leuco dye and the color developer (the color mixture) are crystallized, and its color is maintained. It is considered that the color is stable because of the formation of this structure. On the other hand, the decolored state is a state that they are in a condition of phase separation. In this state, molecules of at least one of the compounds aggregate to form a domain or crystallize. It is considered that the leuco dye and the color developer are separated and in a stable state by aggregation or crystallization. In many cases, complete decoloration occurs when they are of phase separation and the color developer crystallizes.

Here, in both the decoloration from a melted state by slow cooling and the decoloration from a colored state by heating illustrated in FIG. 4A, an aggregation structure changes at T₂, where the phase separation and the crystallization of the color developer occur.

Further, in FIG. 4A, there are cases where poor erasing occurs that erasing is impossible despite heating to an erasing temperature when the recording layer is repeatedly heated to a temperature T₃ above the melting temperature T₁. A reason thereof is presumed that the color developer thermally decomposes, making aggregation or crystallization difficult, and that it becomes difficult to be separated from the leuco dye. Degradation of the thermoreversible recording medium can be suppressed by reducing the difference between the melting temperature T₁ and the temperature T₃ in FIG. 4A when the thermoreversible recording medium is heated.

An image processing device and a conveying container suitably used for the present disclosure will be described hereinafter.

(Image Processing Method and Image Processing Device)

The image processing method is a method for rewriting an image through image erasing and image recording on a thermoreversible recording medium, where the image erasing and the image recording are performed through heating by irradiating the thermoreversible recording medium with a laser light, where the thermoreversible recording medium reversibly changes between the colored state and the decolored state depending on a heating temperature and a cooling time.

The image processing method includes an image erasing step and an image recording step, and further includes other steps appropriately selected depending on the intended purpose.

The image processing method can be suitably performed using an image processing device.

An image processing device of the present invention includes at least one of an image recording unit and an image erasing unit, and further includes other units appropriately selected depending on the intended purpose, where the image recording unit is configured to record an image on a thermoreversible recording medium through heating by irradiating the thermoreversible recording medium with light to obtain a recorded image, and the image erasing unit is configured to erase the recorded image on the thermoreversible recording medium through heating by irradiating the thermoreversible recording medium with light.

Here, the image erasing unit and the image recording unit may be separated from each other in the image processing device.

<Image Recording Unit>

The image recording unit is not particularly limited and may be appropriately selected depending on the intended purpose.

A wavelength of a laser light to be emitted should be selected so that the thermoreversible recording medium, on which an image is to be formed, absorbs the laser light highly efficiently. For example, the thermoreversible recording medium used for the present invention contains a photothermal converting material which has a function of highly efficiently absorbing a laser light to generate heat.

Therefore, the wavelength of the laser light to be emitted should be selected so that the photothermal converting material to be contained absorbs the laser light at higher efficiency than those of all other materials.

The image recording unit includes a laser light emitting unit, and if necessary, further includes other appropriately selected members.

<<Laser Light Emitting Unit>>

The laser light emitting unit in the image recording unit may be appropriately selected depending on the intended purpose. Examples thereof include a semiconductor laser, a solid laser, a fiber laser, and a CO₂ laser. Of these, the semiconductor laser is particularly preferable from the viewpoints of wide selectability of wavelengths, and a small laser light source which can realize down-sizing of a device and reduce cost.

A wavelength of the laser light emitted from the laser light emitting unit is not particularly limited and may be appropriately selected depending on the intended purpose. The lower limit of the wavelength of the laser light is preferably 700 nm or longer, more preferably 720 nm or longer, particularly preferably 750 nm or longer. The upper limit of the wavelength of the laser light is preferably 1,600 nm or shorter, more preferably 1,300 mm or shorter, particularly preferably 1,200 nm or shorter.

The wavelength of the laser light shorter than 700 nm causes the following problem: image contrast is reduced in the visible light region during image recording on the thermoreversible recording medium or the thermoreversible recording medium is disadvantageously colored. In the UV ray region, which has much shorter wavelengths, there is a problem that the thermoreversible recording medium tends to be deteriorated. Moreover, the photothermal converting material to be contained in the thermoreversible recording medium needs to have a high decomposition temperature in order to ensure durability for repeated image processing. Therefore, in the case where an organic dye is used as the photothermal converting material, it is difficult to obtain the photothermal converting material having a high decomposition temperature and long absorption wavelengths. From the reasons as mentioned, the wavelength of the laser light is preferably 1,600 nm or shorter.

The output of the laser light in the image recording unit is not particularly limited and may be appropriately selected depending on the intended purpose. The lower limit of the output of the laser light is preferably 1 W or more, more preferably 3 W or more, particularly preferably 5 W or more. The lower limit of the output of the laser light in the preferable range is advantageous in that it takes a shorter time to record an image, and the output is sufficient even if the time for image recording is shortened. The upper limit of the output of the laser light is preferably 200 W or lower, more preferably 150 W or lower, particularly preferably 100 W or lower. The upper limit of the output of the laser light in the preferable range is advantageous in that an increase in size of the laser device is difficult to cause.

The scanning speed of the laser light in the image recording unit is not particularly limited and may be appropriately selected depending on the intended purpose. The lower limit of the scanning speed of the laser light is preferably 100 mm/s or more, more preferably 300 mm/s or more, particularly preferably 500 mm/s or more. The lower limit of the scanning speed of the laser light in the preferable range is advantageous in that the time for image recording can be shortened. The upper limit of the scanning speed of the laser light is preferably 15,000 mm/s or less, more preferably 10,000 mm/s or less, particularly preferably 8,000 mm/s or less. The upper limit of the scanning speed of the laser light in the preferable range is advantageous in that it becomes easy to form a uniform image.

The spot diameter of the laser light in the image recording unit is not particularly limited and may be appropriately selected depending on the intended purpose. The lower limit of the spot diameter of the laser light is preferably 0.02 mm or more, more preferably 0.1 mm or more, particularly preferably 0.15 mm or more. The lower limit of the spot diameter of the laser light in the preferable range is advantageous in that it is possible to suppress reduction in visibility. The upper limit of the spot diameter of the laser light is preferably 3.0 mm or less, more preferably 2.5 mm or less, particularly preferably 2.0 mm or less. The upper limit of the spot diameter of the laser light in the preferable range is advantageous in that it is difficult for a line width of an image to be widened, so that adjacent lines are not overlapped. As a result, it is possible to record a small image.

Other factors of the image recording unit are not particularly limited, and those described in the present invention and those known in the art can be applied.

FIG. 5 is a schematic view of one example of the image recording unit.

In FIG. 5, an image recording unit 009 irradiates a thermoreversible recording medium (not illustrated) with a laser light 010 through heating to record, for example, a character, a figure, a symbol, or a bar code. The image recording unit 009 includes a control member 019, an optical fiber 018, and an optical head 016.

The control member 019 includes a fiber-bound semiconductor laser (LD) containing: a LD array formed of a plurality of LD light sources; a special optical lens system for converting linear beams from the LD array to circular beams; and an optical fiber 018. This configuration makes it possible to emit circular small beams having high output, and to rapidly record a small character with thin lines.

The optical head 016 includes a collimator lens unit 017, a focal position correcting unit 015, a condenser lens 014, a reflection mirror 013, a galvanometer mirror unit 012, and a laser light emitting opening 011.

The collimator lens unit 017 transforms a laser light passed through the optical fiber 018 into a parallel light. The focal position correcting unit 015 is disposed downstream of the collimator lens unit 017 in the direction of the laser light irradiated, and has a lens position controlling mechanism (not illustrated) configured to move a lens in the direction of the irradiated light, to correct a focal length of the laser light emitted from the optical head 016.

The condenser lens 014 is disposed downstream of the focal position correcting unit 015 in the direction of the laser light irradiated, and converges the laser light passed through the focal position correcting unit 015.

The reflection mirror 013 is disposed downstream of the condenser lens 014 in the direction of the laser light irradiated, and reflects the laser light passed through the condenser lens 014 in the galvanometer mirror unit 012. Therefore, a beam diameter of the laser light to be emitted to the galvanometer mirror unit 012 can be reduced because a long optical path length of the laser light can be long without enlarging a size of the optical head 016.

The galvanometer mirror unit 012 is disposed downstream of the reflection mirror 013 in the direction of the laser light irradiated, and emits the laser light from the laser light emitting opening 011 by changing an angle of the mirror, to scan the light on the thermoreversible recording medium. When the size of the galvanometer mirror unit 012 is large, the image recording is deteriorated in precision. Therefore, a beam diameter of the laser light to be emitted is preferably small.

<<Image Erasing Unit>>

The image erasing unit is not particularly limited and may be appropriately selected depending on the intended purpose. Examples of the image erasing unit include a noncontact heating device using, for example, laser light, hot air, warm water, or an IR heater, and a contact heating device, for example, using a thermal head, a hot stamp, a heat block, or a heat roller. Of these, particularly preferable is a method in which the thermoreversible recording medium is irradiated with laser light.

<<Laser Light Emitting Unit>>

The laser light emitting unit in the image erasing unit is not particularly limited and may be appropriately selected depending on the intended purpose. Examples of the laser light emitting unit include a semiconductor laser, a solid laser, a fiber laser, and a CO₂ laser. Of these, the semiconductor laser is particularly preferable from the viewpoints of wide selectability of wavelengths, and a small laser light source which can realize down-sizing of a device and reduce cost. In order to uniformly erase an image within a short period, a more preferable image erasing unit includes a semiconductor laser array, a width-direction collimating unit, and a length-direction light intensity distribution controlling unit, preferably includes a beam size adjusting unit, and a scanning unit, and if necessary, includes other units.

Here, as one example of the image erasing unit, an image erasing unit including a semiconductor laser array, a width-direction collimating unit, and a length-direction light-intensity-distribution controlling unit will be described hereinafter.

The image erasing unit is configured to erase an image recorded on a thermoreversible recording medium through heating by irradiating the thermoreversible recording medium with line-shaped beams that are longer than a light source length of the semiconductor laser array, and have uniform light intensity distribution in the longitudinal direction, where the thermoreversible recording medium reversibly changes a hue depending on the temperature. The method for erasing an image includes a width-direction collimating step and a length-direction light-intensity-distribution controlling step, further includes a beam-size adjusting step and a scanning step, and further includes other steps, if necessary.

The method for erasing an image includes a step of erasing an image recorded on a thermoreversible recording medium through heating by irradiating the thermoreversible recording medium with line-shaped beams that are longer than a light source length of the semiconductor laser array, and have uniform light intensity distribution in the longitudinal direction, where the thermoreversible recording medium reversibly changes a hue depending on the temperature.

The method for erasing an image can be suitably performed by the image erasing unit, the width-direction collimating step can be performed by the width-direction collimating unit, the length-direction light-intensity-distribution controlling step can be performed by the length-direction light-intensity-distribution controlling unit, the beam-size adjusting step can be performed by the beam-size adjusting step, the scanning step can be performed by the scanning unit, and the other steps can be performed by the other units.

—Laser Diode Array—

The laser diode array is a laser diode light source including a plurality of linearly arranged laser diodes. The number of the laser diodes in the laser diode array is preferably 3 to 300, more preferably 10 to 100. The number of the laser diodes in the preferable range is advantageous in that irradiation energy can be increased sufficiently, and a large-scale cooling device for cooling the laser diode array is not needed.

A light source length of the laser diode array is not particularly limited and may be appropriately selected depending on the intended purpose. Nonetheless, it is preferably 1 mm to 30 mm, more preferably 3 mm to 15 mm. The light source length of the laser diode array in the preferable range is advantageous in that irradiation energy can be increased sufficiently, and a large-scale cooling device for cooling the laser diode array is not needed.

A wavelength of the laser light of the laser diode array is not particularly limited and may be appropriately selected depending on the intended purpose. Nonetheless, the lower limit of the wavelength of the laser light is preferably 700 nm or more, more preferably 720 nm or more, particularly preferably 750 nm or more. The upper limit of the wavelength of the laser light is preferably 1,600 nm or less, more preferably 1,300 mm or less, particularly preferably 1,200 nm or less.

When the wavelength of the laser light is set to a wavelength shorter than 700 nm, there are cases in a visible light region that the contrast of the thermoreversible recording medium decreases during image recording and that the thermoreversible recording medium is colored. In an ultraviolet light region with a further shorter wavelength, there is a problem that degradation of the thermoreversible recording medium is likely to occur. Also, the photothermal conversion material contained in the thermoreversible recording medium is required to have a high decomposition temperature in order to ensure durability against repetitive image processing. It is difficult to obtain a photothermal conversion material having a high decomposition temperature and a long absorption wavelength when an organic dye is used for the photothermal conversion material. Therefore, the wavelength of the laser light is preferably 1,600 nm or less.

—Width-Direction Collimating Step and Unit—

The width-direction collimating step is a step for forming line-shaped beams by collimating laser lights spreading in a width direction irradiated from a laser diode array having a plurality of linearly arranged laser diodes, and it may be carried out by a width-direction collimating unit.

The width-direction collimating unit is not particularly limited and may be appropriately selected depending on the intended purpose. Examples thereof include one single-sided convex cylindrical lens and a combination of a plurality of convex cylindrical lenses.

The laser lights of the laser diode array has a diffusion angle in the width direction larger compared to the length direction. Thus, the width-direction collimating unit arranged close to an irradiation surface of the laser diode array is preferable since it can avoid broadening the beam width and thus reduce the lens size.

—Length-Direction Light Intensity Distribution Controlling Step and Unit—

The length-direction light intensity distribution controlling step is a step for making a length of the line-shaped beams formed in the width-direction collimating step longer than a light source length of the laser diode array as well as making a light intensity distribution thereof uniform in a length direction, and it may be carried out by a length-direction light intensity distribution controlling unit.

The length-direction light intensity distribution controlling unit is not particularly limited and may be appropriately selected depending on the intended purpose. For example, it can be implemented by a combination of two spherical lenses, aspherical cylindrical lenses (length direction) or cylindrical lenses (width direction). Examples of the aspherical cylindrical lens (length direction) include a fresnel lens, a convex lens array and a concave lens array.

The length-direction light intensity distribution controlling unit is arranged on a side of an irradiating surface of the collimating unit.

—Beam-Size Adjusting Step and Unit—

The beam-size adjusting step is a step for adjusting at least any one of a length and a width on a thermoreversible recording medium of the line-shaped beams which are longer than the light source length than the laser diode array and which have a uniform light distribution in the length direction, and it may be carried out by a beam-size adjusting unit.

The beam-size adjusting unit is not particularly limited and may be appropriately selected depending on the intended purpose. Examples thereof include: changing a focal length of a cylindrical lens or a spherical lens; changing a lens installation position; and changing a work distance between the apparatus and the thermoreversible recording medium.

The length of the line-shaped beams after adjustment is preferably 10 mm to 300 mm, more preferably 30 mm to 160 mm. The beam length determines an erasable area. Thus, the short beam length reduces the erasure area, and the with beam width results in addition of energy to an area which needs no erasure. These may cause energy loss and damages.

The beam length is preferably twice or more, more preferably 3 times or more as long as the light source length of the laser diode array. When the beam length is shorter than the light source length of the laser diode array, it becomes necessary to increase the length of the light source of the laser diode array in order to ensure a long erasure area, which may result in increased apparatus cost and apparatus size.

Also, the width of the line-shaped beams after adjustment is preferably 0.1 mm to 10 mm, more preferably 0.2 mm to 5 mm. Adjustment of the beam width can control a heating time of the thermoreversible recording medium. When the beam width is narrow, the short heating time reduces erasability. When the beam width is wide, the long heating time results in application of excess energy on the thermoreversible recording medium, which requires high energy, and erasure at high speed is not possible. It is therefore necessary to adjust the beam width to be appropriate for erasing characteristics of the thermoreversible recording medium.

An output of the thus-adjusted line-shaped beams is not particularly limited and may be appropriately selected depending on the intended purpose. The lower limit of the output is preferably 10 W or more, more preferably 20 W or more, particularly preferably 40 W or more. The output of the laser light in the preferable range is advantageous in that it takes a shorter time to erase an image, and even if the time for image erasing is shortened, the output is sufficient to make it difficult for failure in image erasing to easily occur. Also, the upper limit of the output of the laser light is preferably 500 W or less, more preferably 200 W or less, particularly preferably 120 W or less. The upper limit of the output of the laser light in the preferable range is advantageous in that it is possible to avoid an increase in size of a cooling device of the light source of the laser diodes.

—Scanning Step and Unit—

The scanning step is a step for scanning line-shaped beams, which are longer than the light source length of the laser diode array and have a uniform light intensity distribution in a length direction, on the thermoreversible recording medium in an axial direction, and it may be carried out by the scanning unit.

The scanning unit is not particularly limited as long as the line-shaped beams may be scanned in an axial direction, and it may be appropriately selected depending on the intended purpose. Examples thereof include a uniaxial galvano mirror, a polygon mirror and a stepping motor mirror.

With the uniaxial galvano mirror and the stepping motor mirror, it is possible to finely control speed adjustment. Speed control is difficult with the polygon minor, but it is a low price.

A scanning speed of the line-shaped beams is not particularly limited and may be appropriately selected depending on the intended purpose. Nonetheless, the lower limit of the scanning speed of the line-shaped beams is preferably 2 mm/s or more, more preferably 10 mm/s or more, particularly preferably 20 mm/s or more. The lower limit of the scanning speed in the preferable range is advantageous in that it takes a shorter time to erase an image. Also, the upper limit of the scanning speed is preferably 1,000 mm/s or less, more preferably 300 mm/s or less, particularly preferably 100 mm/s or less. The upper limit of the scanning speed in the preferably range is advantageous in that it becomes easy to uniformly erase an image.

Also, it is preferable to erase an image which has been recorded on the recording medium by conveying the thermoreversible recording medium by a conveying unit with respect to the line-shaped beams which are longer than the light source length of the laser diode array and have a uniform light intensity distribution in a length direction and by scanning the line-shaped beams on the thermoreversible recording medium.

Examples of the conveying unit include a conveyer and a stage. In this case, it is preferable that the thermoreversible recording medium is attached to a surface of a box and that the thermoreversible recording medium is conveyed by conveying the box by a conveyer.

—Other Steps and Units—

The other steps are not particularly limited and may be appropriately selected depending on the intended purpose. Examples of the other steps include a controlling step.

The other units are not particularly limited and may be appropriately selected depending on the intended purpose. Examples of the other units include a controlling unit.

The controlling step is a step for controlling each of the steps and may be favorably carried out by a controlling unit.

The controlling unit is not particularly limited and may be appropriately selected depending on the intended purpose. Examples the controlling unit include devices such as a sequencer and a computer.

Other factors of the image recording unit are not particularly limited, and those described in the present invention and those known in the art can be applied.

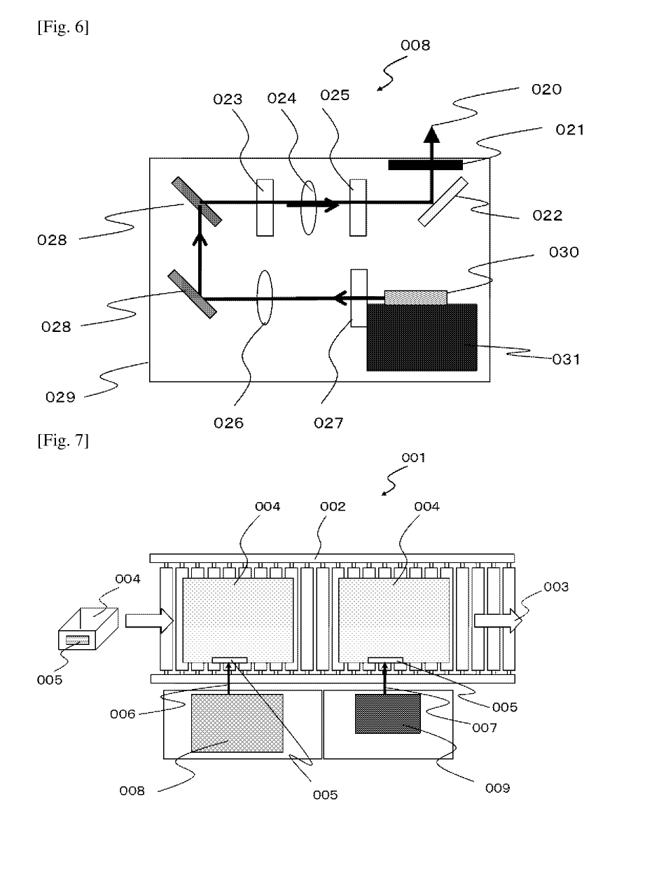

FIG. 6 is a schematic view of one example of the image erasing unit.

In FIG. 6, one example of an image erasing unit 008 including a semiconductor laser array 030, a width-direction collimating unit 027, and a length-direction light-intensity-distribution controlling unit 026 will be described hereinafter.

The image erasing unit 008 includes a width-direction collimating unit 027, a length-direction light-intensity-distribution controlling unit 026, beam-width adjusting units 023, 024, and 025, and scanning mirror 022 served as a scanning unit, and thus a long optical path length is required. Therefore, a reflection mirror 028 is used to form a U-shaped optical path, and a laser-light emitting opening 021 is disposed at the end of the image erasing unit because a long optical path length is secured as much as possible without enlarging a size of the image erasing unit.

Here, in FIG. 6, 020 is a laser emitting light of the image erasing unit, 029 is a casing of the image erasing unit, and 031 is a cooling unit.

<Conveying Container>

A material used for the conveying container is not particularly limited and may be appropriately selected depending on the intended purpose. Examples of the material include wood, paper, cardboard, a resin, a metal, and glass. Of these, the resin is particularly preferable from the viewpoints of formability, durability, and its light weight.

The resin is not particularly limited and may be appropriately selected depending on the intended purpose, and examples thereof include a polyethylene resin, a polypropylene resin, a vinyl chloride resin, a polystyrene resin, an AS resin, an ABS resin, a polyethylene terephthalate resin, an acrylic resin, a polyvinyl alcohol resin, a vinylidene chloride resin, a polycarbonate resin, a polyamide resin, an acetal resin, a polybutylene terephthalate resin, a fluoro resin, a phenolic resin, a melamine resin, a urea resin, a polyurethane resin, an epoxy resin, and an unsaturated polyester resin. These may be used alone or in combination. Of these, the polypropylene resin is preferable from the viewpoints of chemical resistance, mechanical strength, and heat resistance.

In the case where a material used for the conveying container is transparent, a colorant is preferably contained. With a transparent conveying container without the colorant, contents in the conveying container may be visible from outside. Although a transparent conveying container is desired in some cases, when the contents in the conveying container is visible from outside, invasion of privacy or information leakage may be occurred depending on the contents.

—Colorant—

The colorant includes a pigment and a dye. Of these, a pigment being excellent in weather resistance is preferable since a conveying container is repeatedly used in the conveyor line system.

The pigment is not particularly limited and may be appropriately selected depending on the intended purpose, and examples thereof include a phthalocyanine pigment, an isoindolinone pigment, an isoindoline pigment, a quinacridone pigment, a perylene pigment, an azo-pigment, an anthraquinone pigment, titanium oxide, cobalt blue, ultramarine, carbon black, iron oxide, cadmium yellow, cadmium red, chrome yellow, and chromium oxide. These may be used alone or in combination.

In the case of a conveying container made of a resin, for example, the colorant can be kneaded with the resin, when the conveying container is shaped. An amount of the colorant added to the resin may be appropriately selected depending on the intended purpose, but the colorant is preferably added so that contents in the conveying container are invisible from outside.

A method for shaping the conveying container made of the resin is not particularly limited and may be appropriately selected depending on the intended purpose, and examples thereof include extrusion molding, blow molding, vacuum molding, calendar molding, and injection molding. A surface of the conveying container may be coated with a surface protecting agent for the purpose of preventing scratches on the surface of the conveying container. Also, for the purpose of improving appearance of the conveying container, the surface of the conveying container may be coated with a glossing agent, a matting agent, an antifouling agent, or an anti-rust agent. Furthermore, surface of the conveying container may be processed with surface texturing for the purpose of improving releasability of a label.

(Conveyor Line System)

A conveyor line system of the present invention is a conveyor line system configured to control the conveying container on which the thermoreversible recording medium is attached. The conveyor line system includes the image processing device configured to perform at least one of image recording and image erasing by irradiating the thermoreversible recording medium with a laser light, and further includes other devices, if necessary.

The conveyor line system is a system configured to irradiate the thermoreversible recording medium attached on the conveying container moved on a conveyor line with laser light to thereby form an image that indicate, for example, information concerning contents and a delivery destination of goods contained in a conveying container, date, and a management number.

The laser light is irradiated when the thermoreversible recording medium attached on the conveying container moved on the conveyor line reaches a predetermined position. The predetermined position is a position where only the thermoreversible recording medium is irradiated with laser light emitted by the image processing device to rewrite an image on the thermoreversible recording medium. During this operation, in order to obtain a high quality image, the thermoreversible recording medium is preferably irradiated with energy of laser light with at least one of output of a laser light to be emitted, scanning speed, and beam diameter being controlled based on a result obtained by a temperature sensor for detecting a temperature of the thermoreversible recording medium or ambient temperature and a distance sensor for detecting a distance between the recording medium and the image processing device.

Here, the irradiation energy can be represented by the formula: (P×r)/V, where P is an output of the laser light, V is a scanning speed of the laser light, and r is a spot diameter on the medium in a perpendicular direction to the scanning direction of the laser light.

FIG. 7 is a schematic view of one example of a conveyor line system.

In FIG. 7, an image erasing unit 008 and an image recording unit 009 are disposed upstream of the conveyor line 002 in this order. The image erasing unit 008 and the image recording unit 009 are preferably disposed so as to be adjacent each other. In FIG. 7, 001 is a conveyor line system, 003 is a conveying direction of the conveyor line, 004 is a conveying container, 005 is a thermoreversible recording medium, 006 is a laser light of the image erasing unit 008, and 007 is a laser light of the image recording unit 009.

The being adjacent means a state that the image erasing unit 008 and the image recording unit 009 are the most closely disposed, so as not to adversely affect image recording and image erasing, each of which is performed by irradiating the thermoreversible recording medium 005 with a laser light; so as not to adversely affect conveyance of the conveying container 004, which is conveyed on the conveyor line 002; so as not to adversely affect disposition of a control unit, a power cord, and a wiring, where the control unit is configured to control irradiation laser light based on sensor results of the temperature sensor and the distance sensor. Therefore, the image erasing unit 008 unnecessarily contacts with the image recording unit 009. Disposition of the image processing device as described in FIG. 7 enables a safety cover, configured to prevent the laser light from leaking outside, to be compact, compared to the cases where the image erasing unit 008 is disposed away from the image recording unit 009. In the case where the conveying container 004 slips out of position during image recording, and thus a bar code that is an information reading code is not precisely read for image recording to cause reading error at an information reading device disposed downstream of the image recording unit 009, the conveying container 004 exhibiting the reading error and the subsequent conveying containers 004 are required to re-start image erasing. However, in the case where the image erasing unit 008 and the image recording unit 009 are closely disposed, the number of conveying containers to be subjected again to image processing can be reduced, and thus it is possible to rewrite more images of thermoreversible recording mediums 005 attached to conveying containers 004 in a short time, compared to the cases where the image erasing unit 008 is disposed away from the image recording unit 009.

In the conveyor line system of the present disclosure, when an image obtained during the image recording includes a solid image, an average particle diameter of the granules is 0.35 micrometers or less.

Here, the solid image means an image formed by superimposing a plurality of laser light drawn lines on top of one another or an image formed by drawing laser light drawn lines adjacent to each other. Examples thereof include a two-dimensional code (e.g., bar code and QR code (registered trademark)), an outline character, a bold character, a logo, a symbol, a figure, and a picture.

Examples of the bar code include ITF, Code 128, Code 39, JAN, EAN, UPC, and NW-7.

These solid images are formed by superimposing a plurality of laser light drawn lines on top of one another, or by drawing a plurality of laser light drawn lines adjacent to each other, which may lead to heat accumulation of the image. Therefore, when the granules contained in the thermoreversible recording layer of the prepared thermoreversible recording medium are coarse particles, coloring defect and deterioration in coloring density due to excessive heating considerably tends to occur, which makes it difficult to read an image due to poor coloring density of the image, when the solid images are repeatedly recorded during the second recording and subsequent recordings.

<Other Devices>

The other devices are not particularly limited and may be appropriately selected depending on the intended purpose. Examples thereof include a conveyor line configured to convey a conveying container, a device configured to control image information, and an information reading device configured to read a formed image.

The conveyor line system of the present invention is suitably used, for example, for a physical distribution management system, a delivery management system, a storage management system, or a process management system in a factory.

### EXAMPLES

The present invention will next be described by way of Examples, which should not be construed as limiting the present invention.

### Example 1

<Production of Thermoreversible Recording Medium>

A thermoreversible recording medium whose color tone changes reversibly by heat was prepared as follows.

—Support—

As a support, a white polyester film having an average thickness of 125 micrometers (TETORON film U2L98W, manufactured by Teijin DuPont Films Japan) was used.

—Under Layer—

An under layer coating solution was prepared by adding 30 parts by mass of a styrene-butadiene copolymer (PA-9159, manufactured by Nippon A&L Inc.), 12 parts by mass of a polyvinyl alcohol resin (POVAL PVA103, manufactured by Kuraray Co., Ltd.), 20 parts by mass of hollow particles (MICROSPHERE R-300, manufactured by Matsumoto Yushi-Seiyaku Co., Ltd.) and 40 parts by mass of water and stirring the mixture for about 1 hour until it became uniform.

Next, the obtained under layer coating solution was applied on the substrate using a wire bar, which was heated and dried at 80 degrees Celsius for 2 minutes, and an under layer having an average thickness of 20 micrometers was formed.

—Thermoreversible Recording Layer—

Using a ball mill, 5 parts by mass of a reversible color developer represented by Structural Formula (1) below, 0.5 parts by mass, respectively, of two types of decoloring accelerators represented by Structural Formula (2) below and Formula (3) below, 10 parts by mass of a 50-% by mass solution of acrylic polyol (hydroxyl value=200 mg KOH/g) and 100 parts by mass of methyl ethyl ketone were pulverized.

(Reversible Color Developer)

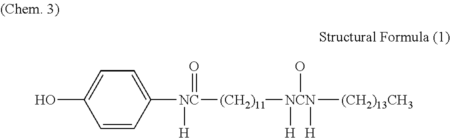

(Decoloration Accelerator)

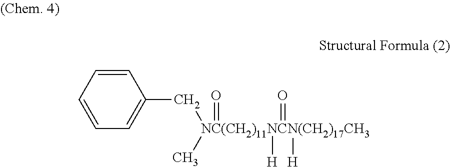

(Decoloration Accelerator)

C₁₇H₃₅CONHC₁₈H₃₇

Next, to the dispersion liquid in which the reversible color developer was pulverized and dispersed, 1 part by mass of 2-anilino-3-methyl-6-diethylaminofluoran as a leuco dye, 1.2 parts by mass of a 1.85-% by mass dispersion solution of LaB₆ as a photothermal conversion material (KHF-7A, manufactured by Sumitomo Metal Mining Co., Ltd.) and 5 parts by mass of an isocyanate (CORONATE HL, manufactured by Nippon Polyurethane Industry Co., Ltd.) were added and stirred well, and thereby a thermoreversible recording layer coating solution was prepared.

Next, the obtained thermoreversible recording layer coating solution was applied on the support with the under layer using a wire bar. It was heated and dried at 100 degrees Celsius for 2 minutes followed by curing at 60 degrees Celsius for 24 hours, and thereby a thermoreversible recording layer having an average thickness of 14.5 micrometers was formed.

—Ultraviolet Barrier Layer—

An ultraviolet barrier layer coating solution was prepared by adding and stirring well 10 parts by mass of a 40-% by mass solution of an UV-absorbing polymer (UV-G302, manufactured by Nippon Shokubai Co., Ltd.), 1.0 part by mass of an isocyanate (CORONATE HL, manufactured by Nippon Polyurethane Industry Co., Ltd.) and 12 parts by mass of methyl ethyl ketone.

Next, the ultraviolet barrier layer coating solution was applied on the thermoreversible recording layer with a wire bar, and it was heated and dried at 90 degrees Celsius for 1 minute followed by heating at 60 degrees Celsius for 24 hours. Thereby, an ultraviolet barrier layer having a thickness of 13.5 micrometers was formed.

—Oxygen Barrier Layer—

An adhesive layer coating solution was prepared by adding and stirring well 5 parts by mass of an urethane adhesive (TM-567, manufactured by Toyo-Morton, Ltd.), 0.5 parts by mass of an isocyanate (CAT-RT-37, manufactured by Toyo-Morton, Ltd.) and 5 parts by mass of ethyl acetate.

Next, the adhesive layer coating solution was applied with a wire bar on a silica-deposited PET film [IB-PET-C, manufactured by Dai Nippon Printing Co., Ltd.; oxygen permeability: 15 mL/(m² day MPa)], and it was heated and dried at 80 degrees Celsius for 1 minute. This was laminated with the ultraviolet barrier layer and heated at 50 degrees Celsius for 24 hours, and thereby, an oxygen barrier layer having an average thickness of 12 micrometers was formed.

—Bonding Agent Layer—

A composition containing 50 parts by mass of an acrylic pressure sensitive adhesive (BPS-1109, product of TOYO INK CO., LTD.) and 2 parts by mass of isocyanate (D-170N, product of MITSUI TAKEDA CHEMICALS, INC) was sufficiently stirred to prepare a bonding agent layer coating liquid

The bonding agent layer coating liquid was coated on the surface of the support opposite to the surface of the support on which the thermoreversible recording layer is provided, using a wire bar, and was dried at 90 degrees Celsius for 2 minutes to form a bonding agent layer having an average thickness of 20 micrometers.

As described above, a thermoreversible recording medium was prepared.

—Measurement of Average Particle Diameter of Granules by Transmission Electron Microscope—

(Procedure)

(1) After cutting an appropriate size of a triangle from the produced thermoreversible recording medium by a pair of scissors, the cross-section of the cut piece, which had an acute angle, and cut in the direction vertical to the thickness direction, was trimmed with a cutter knife.

(2) After securing the thermoreversible recording medium, the cross-section of which had been trimmed, to a sample holder, the sample was embedded using a curable epoxy resin for 30 minutes.

(3) After trimming the sample with a glass knife using an ultramicrotome, a thin piece was produced from the sample using ultrasonic, and the thin piece having a cross-section that was vertical relative to the thickness direction of the thermoreversible recording medium was placed on a mesh with an elastic membrane, followed by air drying the resultant.

(4) After vapor dying the thin piece with a RuO₄ aqueous solution (for 5 minutes at room temperature), followed by drying the thin piece in a draft. The resulting sample piece was then subjected to observation under TEM.

—Cutting Conditions—

Cutting device: ultramicrotome (using thee attached diamond knife (Ultra Sonic35°)) manufactured by Leica Microsystems

Cutting thickness: 80 nm

Cutting speed: from 0.2 mm/sec through 0.6 mm/sec

—Observation Conditions—

Used device: transmission electron microscope, JEM-2100, manufactured by JEOL Ltd.

Accelerating voltage: 200 kV

Observation method: bright-field method

Setting conditions: spot size: 3, CL: 1, OL: 3, others: none, Alpha: 3

The granules in the thermoreversible recording layer on the cross-section vertical to the thickness direction of the produced thermoreversible recording medium to be recorded for the first time after production thereof were observed under a transmission electron microscope with a magnification of 3,000 times. From the obtained two image photographs, major axis diameters a and minor axis diameters b were measured, a value of square root of the product of a and b was determined, and the average particle diameter was determined from the average value of the aforementioned values of the particle diameters of 100 granules. The average particle diameter was 0.273 micrometers.

Using the produced thermoreversible recording medium, a difference in coloring density between the thermoreversible recording medium recorded for the first time after production thereof and the thermoreversible recording medium subjected 10 times to recording and erasing of an image was evaluated in the following manner.

<Image Evaluation 1>

A solid square image having a length of 8.0 mm and a width of 8.0 mm was recorded on the thermoreversible recording medium (medium temperature: 40 degrees Celsius) bonded, via an thickening agent layer, to a transporting container composed of a blue polypropylene (PP) resin plate having the average thickness of 2 mm (PP sheet, manufactured by SANKO Co., Ltd.) by applying laser light having a center wavelength of 980 nm using Ricoh Rewritable Laser Marker (LDM200-110, manufactured by Ricoh Company Limited) under the conditions that the output was 7.7 W (irradiation energy: 5.51 mJ/mm²), irradiation distance was 150 mm, the spot diameter was 0.48 mm, and the scanning speed was 3,000 mm/s. The density of the image was measured by means of a portable spectrophotometer 939 manufactured by X-rite, Inc.

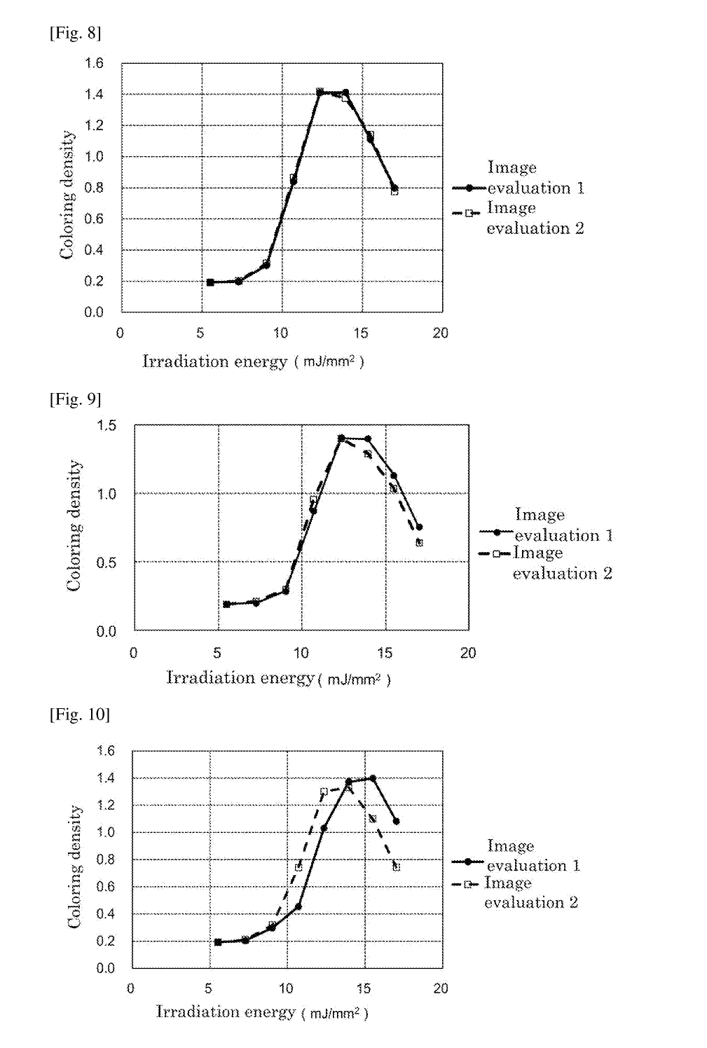

Moreover, images were recorded and coloring density thereof were measured in the same manner as the above, provided that the output was changed to 10.2 W (irradiation energy: 7.29 mJ/mm²), 12.7 W (irradiation energy: 9.02 mJ/mm²), 15.0 W (irradiation energy: 10.70 mJ/mm²), 17.3 W (irradiation energy: 12.34 mJ/mm²), 19.6 W (irradiation energy: 13.94 mJ/mm²), 21.8 W (irradiation energy: 15.49 mJ/mm²), and 23.9 W (irradiation energy: 17.00 mJ/mm²), respectively. The results are presented in FIG. 8.

The density of the image recorded at the output of 17.3 W (irradiation energy: 12.34 mJ/mm²), with which the coloring density exhibited the maximum value, was 1.411.

<Image Evaluation 2>

A Ricoh Rewritable Laser Marker (LDM200-110, manufactured by Ricoh Company Limited) was used to irradiate the thermoreversible recording medium (medium temperature: 40 degrees Celsius) with the laser light having a center wavelength of 980 nm under the following conditions (output: 17.3 W (irradiation energy: 12.34 mJ/mm²), irradiation distance: 150 mm, spot diameter: 0.48 mm, and scanning speed: 3,000 mm/s), to record a square solid image (length: 8.0 mm, width: 8.0 mm), where the thermoreversible recording medium was attached to a conveying container composed of a blue polypropylene (PP) resin plate having an average thickness of 2 mm (PP sheet, manufactured by SANKO Co., Ltd.).

Subsequently, the solid square image was erased by applying laser light having a center wavelength of 976 nm to the thermoreversible recording medium (medium temperature: 40 degrees Celsius), on which the image recording had been performed, using Ricoh Rewritable Laser Eraser (LDE800-A, manufactured by Ricoh Company Limited) under the conditions that the output was 64 W, the irradiation distance was 110 mm, the short beam width was 1.1 mm, and the scanning speed was 46 mm/s.

The image recording and image erasing were repeated 10 times under the aforementioned conditions. The thermoreversible recording medium was visually observed during the image processing, and it was confirmed that a solid square image could be recorded and erased.

As for the image processing, image recording and image erasing were performed in this order, and a repeating cycle was determined once, when image recording and image erasing were both performed once.

An image was recorded on the area, where the image recording and image erasing were repeated 10 times, at each output in the same manner as in Image Evaluation 1, and each coloring density was measured in the same manner as in Image Evaluation 1. The results are depicted in FIG. 8.

The density of the image recorded at the output of 17.3 W (irradiation energy: 12.34 mJ/mm²), which was the same as in Image Evaluation 1, was 1.415.

<Difference in Coloring Density>

Results of the coloring density in Image Evaluation 1 and Image Evaluation 2 were used to evaluate a difference (difference in coloring density) between the coloring density of the thermoreversible recording medium to be recorded for the first time after production thereof and the coloring density of the thermoreversible recording medium obtained after performing the image recording and the image erasing for 10 times based on the following criteria. Note that, an absolute value was used for the difference in coloring density. The results are presented in Table 1 below.

—Evaluation Criteria—

Acceptable: the difference between the coloring density of Image Evaluation 1 and the coloring density of Image Evaluation 2 was less than 0.1.

Not acceptable: the difference between the coloring density of Image Evaluation 1 and the coloring density of Image Evaluation 2 was 0.1 or more.

### Example 2

A thermoreversible recording medium was produced in the same manner as in Example 1, provided that the average particle diameter of the granules in the thermoreversible recording layer was changed to 0.294 micrometers by adjusting the pulverization dispersion conditions, and stirring conditions using a ball mill in the preparation of the thermoreversible recording layer coating liquid of the thermoreversible recording layer. Note that, the average particle diameter of the granules was measured in the same manner as in Example 1.

Next, coloring density at each of the outputs for Image Evaluation 1 and Image Evaluation 2 was measured in the same manner as in Example 1. The results are presented in FIG. 9 and Table 1.

In Image Evaluation 1, the coloring density of the image recorded with output of 17.3 W (irradiation energy: 12.34 mJ/mm²), with which the coloring density reached the maximum value, was 1.404. In Image Evaluation 2, the coloring density of the image recorded with output of 17.3 W (irradiation energy: 12.34 mJ/mm²) was 1.395. Moreover, a difference in coloring density was evaluated in the same manner as in Example 1. The results are presented in Table 1 below.

### Example 3

A thermoreversible recording medium was produced in the same manner as in Example 1, provided that the average particle diameter of the granules in the thermoreversible recording layer was changed to 0.340 micrometers by adjusting the pulverization dispersion conditions, and stirring conditions using a ball mill in the preparation of the thermoreversible recording layer coating liquid of the thermoreversible recording layer. Note that, the average particle diameter of the granules was measured in the same manner as in Example 1.

Next, coloring density at each of the outputs for Image Evaluation 1 and Image Evaluation 2 was measured in the same manner as in Example 1. The results are presented in FIG. 10 and Table 1.

In Image Evaluation 1, the coloring density of the image recorded with output of 19.6 W (irradiation energy: 13.94 mJ/mm²), with which the coloring density reached the maximum value, was 1.372. In Image Evaluation 2, the coloring density of the image recorded with output of 19.6 W (irradiation energy: 13.94 mJ/mm²) was 1.331.

Moreover, a difference in coloring density was evaluated in the same manner as in Example 1. The results are presented in Table 1 below.

### Comparative Example 1

A thermoreversible recording medium was produced in the same manner as in Example 1, provided that the average particle diameter of the granules in the thermoreversible recording layer was changed to 0.381 micrometers by adjusting the pulverization dispersion conditions, and stirring conditions using a ball mill in the preparation of the thermoreversible recording layer coating liquid of the thermoreversible recording layer. Note that, the average particle diameter of the granules was measured in the same manner as in Example 1.

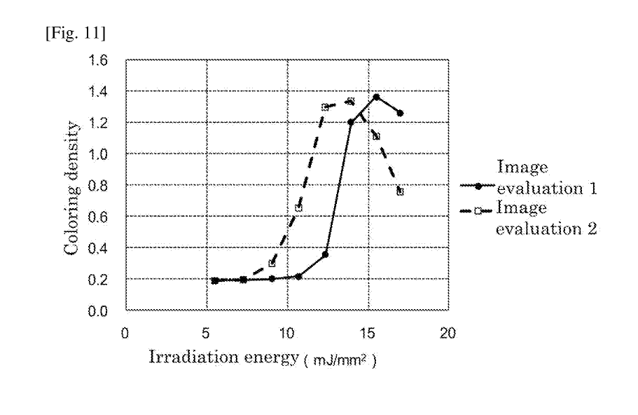

Next, coloring density at each of the outputs for Image Evaluation 1 and Image Evaluation 2 was measured in the same manner as in Example 1. The results are presented in FIG. 11 and Table 1.

In Image Evaluation 1, the coloring density of the image recorded with output of 21.8 W (irradiation energy: 15.49 mJ/mm²), with which the coloring density reached the maximum value, was 1.364. In Image Evaluation 2, the coloring density of the image recorded with output of 21.8 W (irradiation energy: 15.49 mJ/mm²) was 1.111.

Moreover, a difference in coloring density was evaluated in the same manner as in Example 1. The results are presented in Table 1 below.

TABLE 1

| | | Average particle diameter of | Coloring density | | Difference | |
|---|---|---|---|---|---|---|
| | | granules in themoreversible | Image | Image | in coloring | Evaluation |
| | | recording layer (μm) | Recording 1 | Recording 2 | density | results |
| Ex. | 1 | 0.273 | 1.411 | 1.415 | 0.004 | Acceptable |
| | 2 | 0.294 | 1.404 | 1.395 | 0.009 | Acceptable |
| | 3 | 0.340 | 1.372 | 1.331 | 0.041 | Acceptable |
| Comp. | 1 | 0.381 | 1.364 | 1.111 | 0.253 | Not |
| Ex. | | | | | | Acceptable |

### Example 4

A thermoreversible recording medium was produced in the same manner as in Example 1.

<Readability of the Barcode>

<<Image Evaluation 3>>

A transporting container, which was composed of a blue polypropylene (PP) resin plate having the average thickness of 2 mm (PP sheet, manufactured by SANKO Co., Ltd.), and to which the thermoreversible recording medium (medium temperature: 40 degrees Celsius) was bonded via an adhesive layer, was transported by a conveyer device at the transporting speed of 2 m/min. Ricoh Rewritable Laser Eraser (LDE800-A, manufactured by Ricoh Company Limited) was arranged at the area that was upstream of the conveyor device at the one side of the direction crossing the transporting path, and Ricoh Rewritable Laser Marker (LDM200-110, manufactured by Ricoh Company Limited) was arranged at the area that was downstream of the conveyor device at the same side. After applying laser light for image erasing under the same conditions to those for image erasing in Image Evaluation 2, laser light was applied to record a barcode by means of Ricoh Rewritable Laser Marker (LDM200-110, manufactured by Ricoh Company Limited) under the conditions that the output was 17.3 W (irradiation energy: 12.34 mJ/mm²), the irradiation distance was 150 mm, the spot diameter was 0.48 mm, and the scanning speed was 3,000 mm/s. When the barcode was erased, the transporting container was stopped at the position facing the laser eraser to erase the barcode. When a barcode was recorded, the transporting container was stopped at the position facing the laser marker to record a barcode. The obtained barcode was read by means of a handy scanner (THIR-6780U, manufactured by MARS TOHKEN SOLUTION CO. LTD.), and the “readability of the barcode” was evaluated based on the following evaluation criteria. The result is presented in Table 2 below.

—Evaluation Criteria—

Acceptable: the barcode could be read.

Not acceptable: the barcode could not be read.

<<Image Evaluation 4>>

The “readability of the barcode” was evaluated in the same manner as in Image Evaluation 3, provided that the number of the repeating cycle of the erasing and recording of the barcode was changed from once to 10 times in total. The result is presented in Table 2 below.

### Comparative Example 2

Recording of a barcode, or recording of a barcode after repeating a cycle of recording and erasing of a barcode was performed in the same manner as in Example 4, provided that the thermoreversible recording medium was replaced with the thermoreversible recording medium of Comparative Example 1.

The “readability of the barcode” was evaluated in the same manner as in Image Evaluation 3 and Image Evaluation 4 of Example 4. The results are presented in Table 2 below.

TABLE 2

| | | Average particle diameter | Evaluation Result | |
|---|---|---|---|---|
| | | of granules in thermo- | Readability of barcode | |
| | | reversible recording layer | Image | Image |
| | | (μm) | Evaluation 3 | Evaluation 4 |
| Ex. | 4 | 0.273 | Acceptable | Acceptable |
| Comp. Ex. | 2 | 0.381 | Not | Acceptable |
| | | | acceptable | |

For example, the embodiments of the present invention are as follows.

<1> A thermoreversible recording medium including:

a support; and

a thermoreversible recording layer on the support, the thermoreversible recording layer containing a leuco dye and a reversible color developer,

wherein an average particle diameter of granules in the thermoreversible recording layer is 0.35 micrometers or smaller.

<2> The thermoreversible recording medium according to <1>, wherein the thermoreversible recording layer further contains a photothermal converting material.

<3> The thermoreversible recording medium according to <1> or <2>, wherein an image recorded on the thermoreversible recording medium at a time of image recording includes a solid image.

<4> The thermoreversible recording medium according to any one of <1> to <3>, wherein the average particle diameter of the granules is 0.30 micrometers or smaller.

<5> The thermoreversible recording medium according to any one of <1> to <4>, wherein the average particle diameter of the granules is 0.28 micrometers or smaller.

<6> An image processing device including:

an image recording unit configured to apply light to the thermoreversible recording medium according to any one of <1> to <5> to heat the thermoreversible recording medium, to record an image on the thermoreversible recording medium, or

an image erasing unit configured to apply light to the thermoreversible recording medium to heat the thermoreversible recording medium, to erase an image recorded on the thermoreversible recording medium, or

both of the image recording unit and the image erasing unit.

<7> The image processing device according to <6>, wherein the image recording unit is a laser light emitting unit.

<8> The image processing device according to <6> or <7>, wherein the laser light emitting unit is at least one selected from the group consisting of a semiconductor laser, a solid laser, a fiber laser, and a CO₂ laser.

<9> A conveyor line system including the image processing device according to <6> or <7>.

The thermoreversible recording medium according to any one of <1> to <5>, the image processing device according to <6> or <7>, and the conveyor line system according to <9> can solve the aforementioned various problems in the art, and can achieve the object of the present invention.

### REFERENCE SIGNS LIST

001 conveyor line system
002 conveyor line
003 conveying direction of the conveyor line
004 conveying container
005 thermoreversible recording medium
006 laser light from image erasing unit
007 laser light from image recording unit
008 image erasing unit
009 image recording unit
010 laser light emitted from image recording unit
020 laser light emitted from image erasing unit
100 thermoreversible recording medium
101 support
102 thermoreversible recording layer containing a photothermal converting material

### CITATION LIST

### Patent Literature

PTL 1: Japanese Unexamined Patent Application Publication No. 08-156419

1. A thermoreversible recording medium comprising:
a support; and
a thermoreversible recording layer on the support, the thermoreversible recording layer containing a leuco dye and a reversible color developer,
wherein an average particle diameter of granules in the thermoreversible recording layer is 0.35 micrometers or smaller.

2. The thermoreversible recording medium according to claim 1, wherein the thermoreversible recording layer further comprises a photothermal converting material.

3. The thermoreversible recording medium according to claim 1, wherein an image recorded on the thermoreversible recording medium at a time of image recording comprises a solid image.

4. An image processing device comprising:
an image recording unit configured to apply light to a thermoreversible recording medium to heat the thermoreversible recording medium, to record an image on the thermoreversible recording medium, or
an image erasing unit configured to apply light to the thermoreversible recording medium to heat the thermoreversible recording medium, to erase an image recorded on the thermoreversible recording medium, or
both of the image recording unit and the image erasing unit,
wherein the thermoreversible recording medium includes:
a support; and
a thermoreversible recording layer on the support, the thermoreversible recording layer containing a leuco dye and a reversible color developer, and
wherein an average particle diameter of granules in the thermoreversible recording layer is 0.35 micrometers or smaller.

5. A conveyor line system comprising:
an image processing device,
wherein the image processing device includes:
an image recording unit configured to apply light to a thermoreversible recording medium to heat the thermoreversible recording medium, to record an image on the thermoreversible recording medium, or
an image erasing unit configured to apply light to the thermoreversible recording medium to heat the thermoreversible recording medium, to erase an image recorded on the thermoreversible recording medium, or
both of the image recording unit and the image erasing unit,
wherein the thermoreversible recording medium includes:
a support; and
a thermoreversible recording layer on the support, the thermoreversible recording layer containing a leuco dye and a reversible color developer, and
wherein an average particle diameter of granules in the thermoreversible recording layer is 0.35 micrometers or smaller.
